(19) United States
(12) Patent Application Publication
(10) Pub. No.: US 2026/0072456 A1
(43) Pub. Date: Mar. 12, 2026

(54) WATER PURIFIER AND CONTROL METHOD THEREOF

(71) Applicant: COWAY CO., LTD., Gongju-si (KR)

(72) Inventors: Jae Jin HAM, Gongju-si (KR); Woo Jin KANG, Gongju-si (KR); Keun Hwan KIM, Gongju-si (KR); Heung Soo OH, Gongju-si (KR); Gun Wang LEE, Gongju-si (KR); Chang Seob YEOM, Gongju-si (KR); Kang San KUEM, Gongju-si (KR); Cheol Min LEE, Gongju-si (KR); Jae Wook CHO, Gongju-si (KR); Chung Rae KIM, Gongju-si (KR)

(73) Assignee: COWAY CO., LTD., Gongju-si (KR)

(21) Appl. No.: 19/107,394

(22) PCT Filed: Aug. 10, 2023
(86) PCT No.: PCT/KR2023/011887

§ 371 Date: Feb. 27, 2025

(30) Foreign Application Priority Data
Sep. 1, 2022 (KR) 10-2022-0110623

(51) Int. Cl. G05D 7/06; C02F 1/00

(52) U.S. Cl. CPC G05D 7/0623; C02F 1/008; C02F 2209/02; C02F 2209/40

(57) ABSTRACT

A water purifier includes: a tank part that receives fluid from the outside and adjusts the temperature thereof; a discharge flow passage part fluidly connected to the tank part and the outside to form a flow passage through which the temperature-adjusted fluid flows out; a circulation flow passage part fluidly connected to the tank part and the discharge flow passage part to allow the fluid remaining in the discharge flow passage part to flow into the tank part; and a power part disposed in the discharge flow passage part or the circulation flow passage part to provide a conveying force to the fluid such that the fluid returns to the tank part. The circulation flow passage part may be fluidly connected to the discharge flow passage part on one side biased toward the downstream side of the discharge flow passage part.

### TECHNICAL FIELD

The present invention relates to a water purifier and a control method thereof, and more particularly, to a water purifier and a control method thereof capable of maintaining the temperature of fluid extracted after a long period of non-use at a preset temperature.

### BACKGROUND

The water purifier collectively refers to any apparatus that may receive raw water and process it in a state desired by the user, and then provide it to the user. The water purifier may filter raw water using various types of filters and provide it to the user. For example, the water purifier may filter raw water to be suitable for drinking and provide it to the user.

In recent years, water purifiers that can perform additional functions rather than just providing purified water by filtering raw water are gaining popularity as living standards and user needs are diversified. For example, recently, water purifiers that can provide hot water, cold water, and even ice to users have been marketed and sold popularly.

Meanwhile, the usage cycle of the water purifier may be divided into a frequently used time zone and a low-use time zone according to the usage pattern of the user. When hot or cold water is frequently discharged, a device for generating hot or cold water provided in a water purifier is continuously operated. Accordingly, the user may be provided with hot water or cold water having a preset temperature.

The device for generating hot or cold water and the water outlet cock are fluidly connected by a flow passage extending therebetween. Depending on the water outlet pattern or the water outlet state, hot or cold water flowing along the flow passage may partially remain in the flow passage.

Therefore, if hot or cold water is discharged after the water purifier has not been used for a long time, hot or cold water remaining on the flow passage and hot or cold water generated and provided may be mixed and discharged. In this case, there is a concern that in the case of hot water, the temperature is lowered compared to the preset temperature, and in the case of cold water, the temperature is increased compared to the preset temperature.

Moreover, if the length of the flow passage connecting the water outlet cock with the device generating hot or cold water increases, there is a concern that the difference between the preset temperature and the water outlet temperature will increase further.

Accordingly, the user cannot receive hot water or cold water at a desired temperature. As a result, the user's satisfaction may decrease.

Furthermore, devices that generate hot or cold water must additionally generate hot or cold water corresponding to the volume of hot or cold water remaining on the flow passage. Therefore, there is a possibility that the energy efficiency of the entire water purifier will decrease, and the amount of use of raw water and hot or cold water generated by treating the raw water may increase.

Accordingly, technologies for maintaining the temperature of hot or cold water discharged after a long period of non-use have been introduced.

Korean Patent Laid-Open Publication No. 10-2015-0101143 discloses a cold and hot water purifier for rapid heating and cooling. Specifically, it discloses a cold and hot water purifier that can immediately extract water at a desired temperature through rapid heating or cooling even when the user extracts hot or cold water at an unused time zone by adjusting the water level of the hot water tank and the cold water tank based on the amount of use of the hot and cold water obtained according to the user's usage pattern analysis.

However, in the cold and hot water purifier disclosed by the above related art document, a hot water tank and a cold water tank must be additionally operated to extract hot or cold water after a long period of non-use. That is, the related art document above does not provide a method to maintain the temperature of hot or cold water extracted after a long period of non-use without additional operation of the hot water tank and cold water tank.

In addition, the cold and hot water purifier disclosed in the above related art document only discloses a method for operating a device that generates hot or cold water (i.e., hot water tank and cold water tank) itself. That is, the related art document above does not provide a method to prevent situations in which the temperature of hot or cold water is disturbed by residual water remaining on the flow passage through which rapid-heated or cooled hot water or cold water flows.

Korean Patent Registration No. 10-1884736 discloses an under sink type drinking water supplying apparatus. Specifically, it discloses an under sink type drinking water supplying apparatus that can supply both purified water, cold water, and hot water and automatically discharge the remaining water in the pipe through an open drainage valve at all times. The related art document above discloses a technique in which residual water is automatically discharged and even if purified water, cold water, and hot water are discharged after a long period of non-use, mixing with the remaining water is prevented and the temperature of the discharged water is maintained.

However, the drinking water supplying apparatus disclosed in the above related art document is configured to discharge residual water generated during use to the outside. Therefore, as the use of the drinking water supplying apparatus continues, all the residual water that increases is discharged to the outside, and there is a concern that the amount of water used will increase excessively.

In addition, the drinking water supplying apparatus disclosed in the related art document above requires a separate flow passage for discharging the residual water to the outside. Therefore, there is a limitation in that it is difficult to achieve miniaturization of the drinking water supplying apparatus and simplification of the flow passage structure.
Korean Patent Laid-Open Publication No. 10-2015-0101143 (2015.09.03.)
Korean Patent Registration No. 10-1884736 (2018.08.02.)

### DISCLOSURE

### Technical Problem

The present invention is to solve the above problems, and the present invention is directed to providing a water purifier and a control method thereof capable of minimizing a temperature change of a fluid extracted after a long period of non-use.

The present invention is also directed to providing a water purifier and a control method thereof in which an operation for minimizing a temperature change of an extracted fluid may be automatically performed.

The present invention is also directed to providing a water purifier and a control method thereof in which an operation for minimizing a temperature change of an extracted fluid does not affect a fluid extraction process by a user.

The present invention is also directed to providing a water purifier and a control method thereof capable of minimizing additional power required to prevent a temperature change of a fluid.

The present invention is also directed to providing a water purifier and a control method thereof capable of minimizing the amount of discarded fluid.

The present invention is also directed to providing a water purifier and a control method thereof capable of various design modifications while minimizing a temperature change of a fluid extracted after a long period of non-use.

The problems of the present invention are not limited to those mentioned above, and other problems not mentioned will be clearly understood by those of ordinary skill in the art from the following description.

### Technical Solution

According to an aspect of the present invention, provided is a water purifier, including a tank part that receives fluid from the outside and adjusts the temperature thereof; a discharge flow passage part fluidly connected to the tank part and the outside to form a flow passage through which the temperature-adjusted fluid flows out; a circulation flow passage part fluidly connected to the tank part and the discharge flow passage part to allow the fluid remaining in the discharge flow passage part to flow into the tank part; and a power part disposed in the discharge flow passage part or the circulation flow passage part to provide a conveying force to the fluid such that the fluid returns to the tank part, wherein the circulation flow passage part is fluidly connected to the discharge flow passage part on one side biased toward the downstream side of the discharge flow passage part.

In this case, a water purifier may be provided in which the power part is located adjacent to a point where the circulation flow passage part and the discharge flow passage part are fluidly connected.

In addition, a water purifier may be provided in which the tank part includes a main tank member configured to receive and store the fluid; and a first sub tank member fluidly connected to the main tank member and configured to cool the fluid, and the discharge flow passage part includes a main discharge flow passage part fluidly connecting the main tank member and the outside to form a flow passage through which the stored fluid is discharged; and a first discharge flow passage part fluidly connecting the first sub tank member and the outside to form a flow passage through which the cooled fluid is discharged.

In this case, a water purifier may be provided in which the circulation flow passage part includes a first circulation flow passage part fluidly connected to the first discharge flow passage part and the main tank member to form a flow passage through which the fluid remaining in the first discharge flow passage part returns to the first sub tank member.

In addition, a water purifier may be provided in which the circulation flow passage part includes a first circulation flow passage part fluidly connected to the first discharge flow passage part and the first sub tank member to form a flow passage through which the fluid remaining in the first discharge flow passage part returns to the first sub tank member.

In this case, a water purifier may be provided in which the power part includes a first power part disposed in the first discharge flow passage part or the first circulation flow passage part to provide a conveying force to the fluid such that the fluid remaining in the first discharge flow passage part flows along the first circulation flow passage part.

In this case, a water purifier may be provided in which the first circulation flow passage part is fluidly connected to the first discharge flow passage part at one point biased toward the downstream side of the first discharge flow passage part, and the first power part is disposed adjacent to the one point.

In this case, a water purifier may be provided in which the tank part includes a main tank member configured to receive and store the fluid; and a second sub tank member fluidly connected to the main tank member and configured to heat the fluid, and the discharge flow passage part includes a main discharge flow passage part fluidly connecting the main tank member and the outside to form a flow passage through which the stored fluid is discharged; and a second discharge flow passage part fluidly connecting the second sub tank member and the outside to form a flow passage through which the heated fluid is discharged.

In addition, a water purifier may be provided in which the circulation flow passage part includes a second circulation flow passage part fluidly connected to the second discharge flow passage part and the main tank member to form a flow passage through which the fluid remaining in the second discharge flow passage part returns to the second sub tank member.

In this case, a water purifier may be provided in which the circulation flow passage part includes a second circulation flow passage part fluidly connected to the second discharge flow passage part and the second sub tank member to form a flow passage through which the fluid remaining in the second discharge flow passage part returns to the second sub tank member.

In addition, a water purifier may be provided in which the power part includes a second power part disposed in the second discharge flow passage part or the second circulation flow passage part to provide a conveying force to the fluid such that the fluid remaining in the second discharge flow passage part flows along the second circulation flow passage part.

In this case, a water purifier may be provided in which the second circulation flow passage part is fluidly connected to the second discharge flow passage part at one point biased toward the downstream side of the second discharge flow passage part, and the second power part is disposed adjacent to the one point.

In addition, according to another aspect of the present invention, provided is a control method of a water purifier, including (a) generating, by a sensor part, detection information on a state of fluid remaining in a discharge flow passage part; (b) stopping, by a controller, inflow of the fluid from the outside; (c) flowing, by the controller, the remaining fluid to the tank part through a circulation flow passage part fluidly connected to the discharge flow passage part; and (d) initiating, by the controller, the inflow of the fluid from the outside.

In this case, a control method of a water purifier may be provided in which the step (a) includes (a1) generating, by an external temperature sensor, detection information on the external temperature; (a2) generating, by an internal temperature sensor, detection information on the temperature inside the discharge flow passage part; (a3) generating, by an outflow sensor, detection information on whether the fluid flows out through the discharge flow passage part; and (a4) transmitting, by the external temperature sensor, the internal temperature sensor, and the outflow sensor, the generated detection information to the controller.

In addition, a control method of a water purifier may be provided in which the step (a2) includes (a21) generating, by a first internal temperature sensor, detection information on the temperature inside a first discharge flow passage part; and (a22) generating, by a second internal temperature sensor, detection information on the temperature inside a second discharge flow passage part.

In this case, a control method of a water purifier may be provided in which the step (b) includes (b1) generating, by an inflow sensor, detection information on whether the fluid is introduced through an inflow passage fluidly connecting the outside and the tank part; (b2) computing, by a computation module, inflow control information for stopping the inflow of the fluid through the inflow passage using the generated detection information; and (b3) controlling, by a flow passage control module, an inflow valve disposed on the inflow passage according to the computed inflow control information to stop the inflow of the fluid.

In addition, a control method of a water purifier may be provided in which the step (c) includes (c1) computing, by a computation module, flow passage information on a flow passage of the fluid formed in the discharge flow passage part using the generated detection information; (c2) computing, by the computation module, circulation control information for forming a flow passage in the circulation flow passage part using the computed flow passage information; and (c3) operating, by a flow passage control module, a power part disposed in the discharge flow passage part or the circulation flow passage part according to the computed circulation control information.

In this case, a control method of a water purifier may be provided in which the step (c1) includes (c11) computing, by a first flow passage information computation unit, first flow passage information on the flow passage of the fluid formed in a first discharge flow passage part, the step (c2) includes (c21) computing, by a first circulation control information computation unit, first circulation control information for returning the fluid remaining in the first discharge flow passage part to the tank part through a first circulation flow passage part, and the step (c3) includes (c31) operating, by a first flow passage control unit, a first power part according to the computed first circulation control information.

In addition, a control method of a water purifier may be provided in which the step (c1) includes (c12) computing, by a second flow passage information computation unit, second flow passage information on the flow passage of the fluid formed in a second discharge flow passage part, the step (c2) includes (c22) computing, by a second circulation control information computation unit, second circulation control information for returning the fluid remaining in the second discharge flow passage part to the tank part through a second circulation flow passage part, and the step (c3) includes (c32) operating, by a second flow passage control unit, a second power part according to the computed second circulation control information.

In this case, a control method of a water purifier may be provided in which the step (d) includes (d1) generating, by an inflow sensor, detection information on whether the fluid is introduced through an inflow passage fluidly connecting the outside and the tank part; (d2) computing, by a computation module, inflow control information for initiating the inflow of the fluid through the inflow passage using the generated detection information; and (d3) controlling, by a flow passage control module, an inflow valve disposed on the inflow passage according to the computed inflow control information to initiate the inflow of the fluid.

### Advantageous Effect

According to the above configuration, the water purifier and the control method thereof according to an exemplary embodiment of the present invention can minimize a temperature change of a fluid extracted after a long period of non-use.

The water purifier according to an exemplary embodiment of the present invention is provided with a tank part for receiving and accommodating fluid from the outside. The tank part includes a main tank member for accommodating the received fluid, and a sub tank member for heating or cooling the accommodated fluid. The main tank member and the sub tank member are fluidly connected to the outside through different discharge flow passage parts.

In this case, the discharge flow passage part fluidly connected to the sub tank member is coupled to a circulation flow passage part, respectively. The circulation flow passage part extends between the sub tank member and the discharge flow passage part, respectively, and is fluidly connected to each of them.

A power part is disposed in the circulation flow passage part or the discharge flow passage part. The power part provides a conveying force for flowing the fluid remaining in the discharge flow passage part to return to the sub tank member through the circulation flow passage part.

Therefore, when not used for a long time, the fluid remaining in the discharge flow passage part is returned to the tank part to be accommodated, heated, or cooled. Therefore, the fluid flowing out of the tank part may be provided to the user without mixing with the remaining fluid. As a result, when the extraction of the fluid is resumed, the temperature of the fluid flowing out of the tank part may be extracted according to a preset temperature, that is, a temperature desired by the user.

Accordingly, the satisfaction level of the user can be increased.

In addition, according to the above configuration, the water purifier and the control method thereof according to an exemplary embodiment of the present invention can automatically perform an operation to minimize a temperature change of the extracted fluid.

The water purifier according to an exemplary embodiment of the present invention is provided with a sensor part. The sensor part is disposed at various locations such as the outside of the water purifier, the inflow passage, the outflow passage, and the discharge flow passage to generate various detection information on the state of the water purifier and the state of the fluid flowing in the water purifier.

The water purifier according to an exemplary embodiment of the present invention includes a controller. The controller computes various information related to whether the fluid extraction process is in progress, the elapsed time if the extraction process is not in progress, and whether an additional fluid flows into the tank part, using the generated detection information.

The controller may compute control information for controlling each component of the water purifier using the computed information. The computed control information may include information for controlling the power part to allow or block the inflow of additional fluid into the tank part, and to return the fluid remaining on the discharge flow passage part to the tank part by controlling the inflow valve.

That is, the controller can compute information on the state of the water purifier using the detection information generated by the sensor part, and accordingly, automatically perform and terminate the return process of the fluid remaining in the discharge flow passage part.

Accordingly, even if the user does not apply a separate control signal, the fluid remaining in the discharge flow passage part may be returned to the tank part.

In addition, according to the above configuration, in the water purifier and the control method thereof according to an exemplary embodiment of the present invention, an operation for minimizing a temperature change of an extracted fluid may not affect a fluid extraction process by a user.

As described above, the controller can automatically perform a process for returning the fluid remaining in the discharge flow passage part to the tank part. In this case, the controller may perform a process for returning the fluid remaining in the discharge flow passage part to the tank part only when the time when the fluid is not extracted through the outflow passage is more than or equal to a preset reference time.

Therefore, if the user is extracting the fluid or if less than a preset reference time has elapsed since the fluid was extracted, the process of returning the fluid remaining in the discharge flow passage part to the tank part does not proceed. That is, the fluid return process may proceed only when the user does not use the water purifier for a time equal to or greater than the preset reference time.

As a result, the user may freely extract the fluid at the desired time point without being affected by the fluid return process.

In addition, according to the above configuration, the water purifier and the control method thereof according to an exemplary embodiment of the present invention can minimize additional power required to prevent a temperature change of a fluid.

The power part provides the necessary conveying force to flow the fluid remaining in the discharge flow passage part back to the tank part. The power part may be provided in an arbitrary form, for example, in the form of a pump, capable of providing a conveying force to the fluid.

That is, the power part does not reheat or re-cool the remaining fluid. The recovered fluid is accommodated, heated, and cooled by a tank part previously provided in the water purifier.

Therefore, even if only the configuration for providing the conveying force to the fluid is added, the fluid remaining in the discharge flow passage part can be effectively recovered. Accordingly, it is not necessary to provide an additional member to cool or heat the entire discharge flow passage part, thereby reducing manufacturing costs and reducing power required for the operation of the water purifier.

In addition, according to the above configuration, the water purifier and the control method thereof according to an exemplary embodiment of the present invention can minimize the amount of discarded fluid.

As described above, the circulation flow passage part is fluidly connected to the discharge flow passage part and the tank part, respectively. The fluid remaining in the discharge flow passage part may not be discharged to the outside and discarded, but may be returned to the tank part and utilized.

Therefore, the entire fluid introduced into the tank part may be provided to the user. In other words, all fluids supplied to the tank part from the outside are provided to the user, and the amount of fluid arbitrarily discharged and discarded is minimized.

That is, even if the fluid remains in the discharge flow passage part, it can be recovered to the tank part and reused, so the amount of fluid supplied to the tank part is not excessively required.

In addition, according to the above configuration, the water purifier and the control method thereof according to an exemplary embodiment of the present invention can be variously designed and modified while minimizing a temperature change of the fluid extracted after a long period of non-use.

The tank part includes a main tank member, a first sub tank member, and a second sub tank member. The main tank member accommodates fluid transferred from the outside. The first and second sub tank members are respectively fluidly connected to the main tank member to receive fluid. The first and second sub tank members cool or heat the transferred fluid, respectively.

In an embodiment, the circulation flow passage part may be fluidly connected to the main tank member and the discharge flow passage part, respectively. In the above embodiment, the fluid recovered from the discharge flow passage part may be introduced into the main tank member via the circulation flow passage part. The fluid introduced into the main tank member may be introduced into the first sub tank member or the second sub tank member to be re-cooled or reheated.

In another embodiment, the circulation flow passage part may be connected to the first and second sub tank members and the discharge flow passage part, respectively. In the above embodiment, the fluid recovered from the discharge flow passage part may be directly introduced into the first sub tank member or the second sub tank member via the circulation flow passage part. The fluid introduced into each sub tank member may be re-cooled or reheated.

Accordingly, the circulation flow passage part may be formed in an arbitrary shape fluidly connecting the discharge flow passage part and the tank part. As a result, the degree of design freedom can be improved depending on the shape and size of the water purifier.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a schematic diagram illustrating a water purifier according to an exemplary embodiment of the present invention.

FIG. 2 is a schematic diagram illustrating a water purifier according to another exemplary embodiment of the present invention.

FIG. 3 is a block diagram illustrating a configuration of a water purifier according to an exemplary embodiment of the present invention.

FIG. 4 is a schematic diagram illustrating a circulation flow passage of a fluid formed in the water purifier of FIG. 1.

FIG. 5 is a schematic diagram illustrating a circulation flow passage of a fluid formed in the water purifier of FIG. 2.

FIG. 6 is a flowchart illustrating a flow of a control method of a water purifier according to an exemplary embodiment of the present invention.

FIG. 7 is a flowchart illustrating a detailed flow of step S100 of the control method of FIG. 6.

FIG. 8 is a flowchart illustrating a detailed flow of step S200 of the control method of FIG. 6.

FIG. 9 is a flowchart illustrating a detailed flow of step S300 of the control method of FIG. 6.

FIG. 10 is a flowchart illustrating a detailed flow of step S400 of the control method of FIG. 6.

### MODES OF THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

In the following description, in order to clarify the features of the present invention, descriptions of some components may be omitted.

The term “communication” used in the following description means that one or more members are connected to each other so as to be in fluid communication. In an embodiment, the communication may be formed by a member such as a conduit, a pipe, a tubing, or the like. In the following description, communication may be used in the same sense as one or more members are being “fluidly connected” to each other.

The term “energization or energizably connected” used in the following description means that one or more members are connected to each other so as to transmit an electric current or an electrical signal. In an embodiment, the energization may be formed in a wired form by a wire member or the like or in a wireless form such as Bluetooth, Wi-Fi, RFID, or the like. In an embodiment, the energization may include the meaning of “communication.”

The term “fluid” used in the following description refers to any form of material that flows by external force and whose shape or volume can be changed. In an embodiment, the fluid may be a liquid such as water or a gas such as air.

The terms “above or upper side”, “below or lower side” “left side”, “right side”, “front side”, and “rear side” used in the following description will be understood with reference to the coordinate system shown throughout the accompanying drawings.

The water purifier 10 according to an exemplary embodiment of the present invention may maintain the temperature of a fluid discharged after a long period of non-use at a preset temperature. In an embodiment, the fluid is provided as cold water or hot water, and the user may receive cold water or hot water having a preset temperature. Accordingly, the user's convenience and satisfaction may be improved.

Specifically, the water purifier 10 according to an exemplary embodiment of the present invention may return the fluid remaining on the flow passage through which the fluid flows for outlet to a component for heating or cooling. Therefore, the amount of fluid remaining on the flow passage is minimized, and thus the disturbance of the temperature of the newly extracted fluid may be minimized.

Meanwhile, since the fluid remaining on the flow passage returns to a component for heating or cooling, a separate member for discharging the remaining fluid to the outside is not required. Furthermore, since the fluid remaining on the flow passage may be provided to the user after being heated or cooled again, the consumption of the fluid may also be reduced.

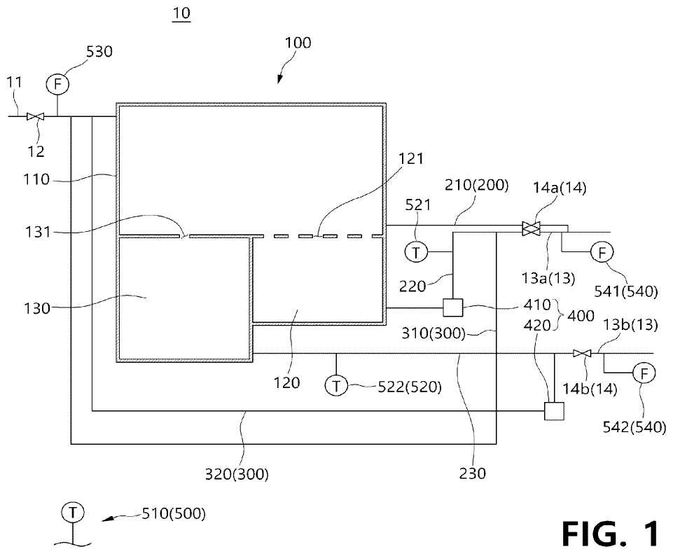

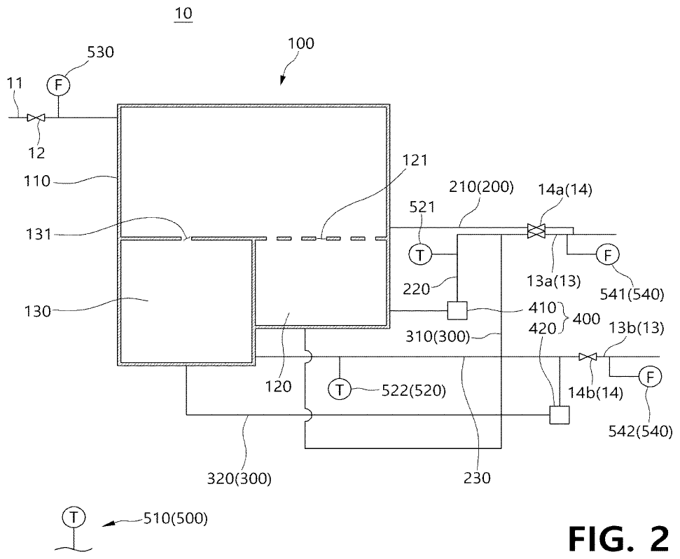

Referring to FIGS. 1 to 2, the water purifier 10 includes an inflow passage 11, an inflow valve 12, an outflow passage 13, and an outflow valve 14. The water purifier 10 is fluidly connected to the outside by the inflow passage 11 and the outflow passage 13.

Specifically, the water purifier 10 is fluidly connected to a filtration member (not shown) provided in the water purifier 10 through the inflow passage 11. The water purifier 10 may receive a fluid, for example, purified water, treated by the filtration member (not shown) through the inflow passage 11.

The inflow valve 12 is provided on the inflow passage 11 so that fluid connection between the water purifier 10 and the filtration member (not shown) may be allowed or blocked. The inflow valve 12 may be provided in any form capable of opening or closing the inflow passage 11, for example, in the form of a gate valve.

In addition, the water purifier 10 is fluidly connected to the outside through the outflow passage 13. A fluid treated while passing through the water purifier 10, such as a fluid filtered, heated or cooled, may be extracted through the outflow passage 13 and provided to the user.

In this case, the outflow passage 13 may be provided in plural. Cold water or purified water may flow in one of the plurality of outflow passages 13 and hot water may flow in the other. In the illustrated embodiment, the outflow passage 13 includes a first outflow passage 13a through which purified water or cold water flows and a second outflow passage 13b through which hot water flows.

The outflow valve 14 is provided on the outflow passage 13 so that fluid connection between the water purifier 10 and the outside may be allowed or blocked. In this case, a plurality of outflow valves 14 may be provided, and may be provided on the plurality of outflow passages 13, respectively. In the illustrated embodiment, the outflow valve 14 includes a first outflow valve 14a disposed in the first outflow passage 13a and a second outflow valve 14b disposed in the second outflow passage 13b.

The outflow valve 14 may be provided in an arbitrary form capable of opening or closing the outflow passage 13, for example, in the form of a gate valve.

In an embodiment, the inflow valve 12 and the outflow valve 14 may communicate with and be energized with a controller 600, respectively. In the above embodiment, the operation of the inflow valve 12 and the outflow valve 14 may be controlled by the controller 600 to open or close the inflow passage 11 and the outflow passage 13, respectively. Accordingly, the flow passage formed inside the water purifier 10 may be changed, and a detailed description thereof will be described later.

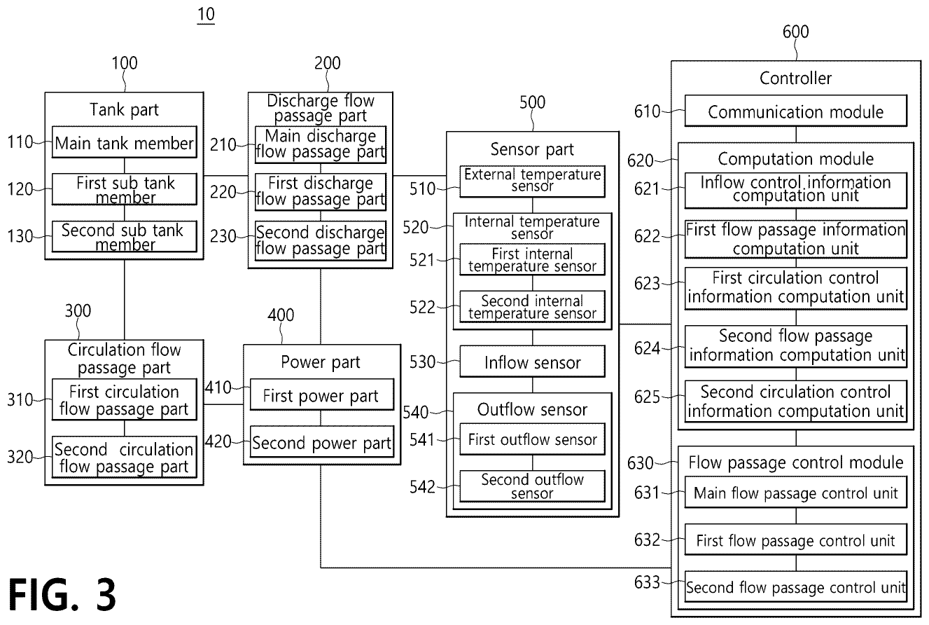

In the embodiments shown in FIGS. 1 to 3, the water purifier 10 includes a tank part 100, a discharge flow passage part 200, a circulation flow passage part 300, a power part 400, a sensor part 500, and a controller 600.

The tank part 100 receives and stores the fluid filtered by the filtration member (not shown). The tank part 100 is fluidly connected to the filtration member (not shown) through the inflow passage 11. A space is formed inside the tank part 100 to accommodate the received fluid.

The tank part 100 may provide the stored fluid to the outside. The tank part 100 is fluidly connected to the outside through the outflow passage 13.

The tank part 100 may include a plurality of components. Any one of the plurality of components may accommodate the received fluid. Any other one of the plurality of components may heat the received and accommodated fluid. Another one of the plurality of components may cool the received and accommodated fluid.

In the illustrated embodiment, the tank part 100 includes a main tank member 110, a first sub tank member 120, and a second sub tank member 130.

The main tank member 110 accommodates the fluid transferred through the inflow passage 11. In an embodiment, the fluid transferred to and accommodated in the main tank member 110 may be purified water. In the above embodiment, the main tank member 110 may be referred to as a “purified water tank”.

The main tank member 110 is fluidly connected to the first sub tank member 120 and the second sub tank member 130, respectively. The fluid transferred to the main tank member 110 may flow to the first sub tank member 120 or the second sub tank member 130.

In the illustrated embodiment, the main tank member 110 is located above the first sub tank member 120 and the second sub tank member 130. In the above embodiment, the fluid accommodated inside the main tank member 110 may be transferred to the first sub tank member 120 or the second sub tank member 130 by gravity without a separate power source.

The main tank member 110 may be formed to have a larger volume than the first sub tank member 120 and the second sub tank member 130. From the viewpoint of the water purifier 10, it is due to the fact that the amount of purified water discharged is greater than that of cold water or hot water.

The main tank member 110 is coupled to the inflow passage 11 so that it is fluidly connected to an external filtration member (not shown). The fluid passing through the filtration member (not shown) may flow into the main tank member 110.

The main tank member 110 is fluidly connected to the first outflow passage 13a through a main discharge flow passage part 210 of the discharge flow passage part 200. The fluid accommodated in the main tank member 110 may sequentially flow through the main discharge flow passage part 210 and the first outflow passage 13a to be extracted to the outside.

The first sub tank member 120 is located adjacent to the main tank member 110.

The first sub tank member 120 receives and stores the fluid accommodated in the main tank member 110. The first sub tank member 120 is configured to cool the stored fluid. In an embodiment in which purified water is stored inside the main tank member 110, the first sub tank member 120 may be referred to as a “cold water tank”.

The first sub tank member 120 is fluidly connected to the main tank member 110. In the illustrated embodiment, the first sub tank member 120 is located below the main tank member 110, so that the fluid stored in the main tank member 110 may flow to the first sub tank member 120 by gravity.

The first sub tank member 120 is fluidly connected to the first outflow passage 13a through a first discharge flow passage part 220 of the discharge flow passage part 200. The fluid accommodated and cooled in the first sub tank member 120 may sequentially flow through the first discharge flow passage part 220 and the first outflow passage 13a to be extracted to the outside.

In the illustrated embodiment, the first sub tank member 120 includes a first sub communication portion 121.

The first sub communication portion 121 fluidly connects the first sub tank member 120 and the main tank member 110. The first sub communication portion 121 is located on one side where the first sub tank member 120 and the main tank member 110 are located adjacent to each other, that is, on the upper side of the first sub tank member 120 in the illustrated embodiment. The first sub communication portion 121 may be formed to be open to communicate the inside of the first sub tank member 120 with the inside of the main tank member 110.

The first sub communication portion 121 may be formed in plural. The plurality of first sub communication portions 121 are provided in five, and are disposed to be spaced apart from each other in the left-right direction. The number and arrangement method of the first sub communication portions 121 may be changed.

The second sub tank member 130 is located adjacent to the first sub tank member 120 and physically spaced apart from the first sub tank member 120.

The second sub tank member 130 receives and stores the fluid accommodated in the main tank member 110. The second sub tank member 130 is configured to heat the stored fluid. In an embodiment in which purified water is stored inside the main tank member 110, the second sub tank member 130 may be referred to as a “hot water tank”.

The second sub tank member 130 is fluidly connected to the main tank member 110. In the illustrated embodiment, the second sub tank member 130 is located below the main tank member 110, so that the fluid stored in the main tank member 110 may flow to the second sub tank member 130 by gravity.

The second sub tank member 130 is located adjacent to the first sub tank member 120. In the illustrated embodiment, the second sub tank member 130 is located to the left of the first sub tank member 120. In this case, the second sub tank member 130 and the first sub tank member 120 are fluidly blocked from each other. Accordingly, mixing of fluids accommodated in each of the sub tank members 120 and 130 may be prevented.

The second sub tank member 130 is fluidly connected to the second outflow passage 13b through a second discharge flow passage part 230 of the discharge flow passage part 200. The fluid accommodated and heated in the second sub tank member 130 may sequentially flow through the second discharge flow passage part 230 and the second outflow passage 13b to be extracted to the outside.

In the illustrated embodiment, the second sub tank member 130 includes a second sub communication portion 131.

The second sub communication portion 131 fluidly connects the second sub tank member 130 and the main tank member 110. The second sub communication portion 131 is located on one side where the second sub tank member 130 and the main tank member 110 are located adjacent to each other, that is, on the upper side of the second sub tank member 130 in the illustrated embodiment. The second sub communication portion 131 may be formed to be open to communicate the inside of the second sub tank member 130 with the inside of the main tank member 110.

In the illustrated embodiment, the second sub communication portion 131 is formed in singular. Alternatively, the second sub communication portion 131 may be formed in plural and they may be disposed to be spaced apart from each other in the left-right direction.

The discharge flow passage part 200 fluidly connects the tank part 100 to the outside. The discharge flow passage part 200 forms a part of a flow passage through which the fluid accommodated in the tank part 100 is provided to the user.

The discharge flow passage part 200 is fluidly connected to the tank part 100. In the illustrated embodiment, the upstream side of the discharge flow passage part 200 is fluidly connected to the tank part 100. The fluid accommodated, heated, or cooled in the tank part 100 may flow out to the outside of the tank part 100 through the discharge flow passage part 200.

The discharge flow passage part 200 is fluidly connected to the outflow passage 13. In the illustrated embodiment, the downstream side of the discharge flow passage part 200 is fluidly connected to the outflow passage 13. The fluid flowing in the discharge flow passage part 200 may be extracted to the outside of the water purifier 10 through the outflow passage 13.

In addition, in the water purifier 10 according to an exemplary embodiment of the present invention, the discharge flow passage part 200 is fluidly connected to the circulation flow passage part 300. The fluid remaining in the discharge flow passage part 200 may return to the tank part 100 through the circulation flow passage part 300. Accordingly, the temperature of the fluid flowing out of the tank part 100 may be maintained at a preset temperature, and the utilization of the fluid may be increased.

In the illustrated embodiment, the discharge flow passage part 200 includes a main discharge flow passage part 210, a first discharge flow passage part 220, and a second discharge flow passage part 230.

The main discharge flow passage part 210 fluidly connects the main tank member 110 to the first outflow passage 13a. The main discharge flow passage part 210 extends between the main tank member 110 and the first outflow passage 13a.

The upstream side of the main discharge flow passage part 210 is fluidly connected to the main tank member 110. In an embodiment, the upstream side of the main discharge flow passage part 210 may be fluidly connected to the main tank member 110 at a position adjacent to the lower side of the main tank member 110. In the above embodiment, the fluid accommodated in the main tank member 110 may flow smoothly to the main discharge flow passage part 210.

The downstream side of the main discharge flow passage part 210 is fluidly connected to the first outflow passage 13a. In this case, the downstream end of the main discharge flow passage part 210 may be fluidly connected to the first outflow passage 13a through the first outflow valve 14a provided in the first outflow passage 13a.

In an embodiment in which purified water is accommodated inside the main tank member 110, the main discharge flow passage part 210 may be referred to as a “purified water discharge flow passage”.

In the illustrated embodiment, the circulation flow passage part 300 is not provided in the main discharge flow passage part 210. This is due to the relatively small need for maintaining the temperature in the case of the fluid flowing in the main discharge flow passage part 210. Alternatively, the circulation flow passage part 300 may also be provided in the main discharge flow passage part 210, forming a flow passage for returning the fluid remaining in the main discharge flow passage part 210 to the main tank member 110.

The first discharge flow passage part 220 fluidly connects the first sub tank member 120 to the first outflow passage 13a. The first discharge flow passage part 220 extends between the first sub tank member 120 and the first outflow passage 13a.

The upstream side of the first discharge flow passage part 220 is fluidly connected to the first sub tank member 120. In an embodiment, the upstream side of the first discharge flow passage part 220 may be fluidly connected to the first sub tank member 120 at a position adjacent to the lower side of the first sub tank member 120. In the above embodiment, the fluid accommodated in the first sub tank member 120 may flow smoothly to the first discharge flow passage part 220.

The downstream side of the first discharge flow passage part 220 is fluidly connected to the first outflow passage 13a. In this case, the downstream end of the first discharge flow passage part 220 may be fluidly connected to the first outflow passage 13a through the first outflow valve 14a provided in the first outflow passage 13a.

In an embodiment, the upstream side of the first outflow passage 13a may be branched into a plurality of branches to be coupled to and communicate with the first outflow valve 14a, respectively. In this case, one of a plurality of upstream ends of the first outflow passage 13a may be coupled to and communicate with the downstream end of the main discharge flow passage part 210 and another of the plurality of upstream ends of the first outflow passage 13a may be coupled to and communicate with the downstream end of the first discharge flow passage part 220.

To this end, the first outflow valve 14a may include a plurality of valves that are physically spaced apart from each other and are fluidly connected to the outside, respectively. That is, flow passages independent of each other are formed between the main tank member 110 and the first outflow passage 13a, and between the first sub tank member 120 and the first outflow passage 13a.

Therefore, each fluid flowing in the main discharge flow passage part 210 and the first discharge flow passage part 220 may not be mixed with each other and may be provided to the user.

In an embodiment in which cold water is generated and accommodated by cooling purified water inside the first sub tank member 120, the first discharge flow passage part 220 may be referred to as a “cold water discharge flow passage”.

The first discharge flow passage part 220 is fluidly connected to a first circulation flow passage part 310 of the circulation flow passage part 300. The fluid discharged from the first sub tank member 120 and remaining in the first discharge flow passage part 220 may return to the tank part 100 through the first circulation flow passage part 310.

A first power part 410 may be provided to provide a conveying force required for the fluid remaining in the first discharge flow passage part 220 to flow toward the tank part 100. As described later, the first power part 410 may be provided in the first discharge flow passage part 220 or the first circulation flow passage part 310.

In this case, the first circulation flow passage part 310 may be coupled to and communicate with the first discharge flow passage part 220 at a part adjacent to the downstream end of the first discharge flow passage part 220. In the above embodiment, the distance between the part where the first discharge flow passage part 220 is coupled to and communicates with the first circulation flow passage part 310 and the downstream end of the first discharge flow passage part 220 is minimized, so that the amount of fluid remaining on the first discharge flow passage part 220 may be minimized.

In addition, the conveying force applied by the first power part 410 may be minimally lost to be transmitted to the fluid remaining in the first discharge flow passage part 220.

The second discharge flow passage part 230 fluidly connects the second sub tank member 130 to the second outflow passage 13b. The second discharge flow passage part 230 extends between the second sub tank member 130 and the second outflow passage 13b.

The upstream side of the second discharge flow passage part 230 is fluidly connected to the second sub tank member 130. In an embodiment, the upstream side of the second discharge flow passage part 230 may be fluidly connected to the second sub tank member 130 at a position adjacent to the lower side of the second sub tank member 130. In the above embodiment, the fluid accommodated in the second sub tank member 130 may flow smoothly to the second discharge flow passage part 230.

The downstream side of the second discharge flow passage part 230 is fluidly connected to the second outflow passage 13b. In this case, the downstream end of the second discharge flow passage part 230 may be fluidly connected to the second outflow passage 13b through the second outflow valve 14b provided in the second outflow passage 13b.

In an embodiment in which hot water is generated and accommodated by heating purified water inside the second sub tank member 130, the second discharge flow passage part 230 may be referred to as a “hot water discharge flow passage”.

The second discharge flow passage part 230 is fluidly connected to a second circulation flow passage part 320 of the circulation flow passage part 300. The fluid discharged from the second sub tank member 130 and remaining in the second discharge flow passage part 230 may return to the tank part 100 through the second circulation flow passage part 320.

A second power part 420 may be provided to provide a conveying force required for the fluid remaining in the second discharge flow passage part 230 to flow toward the tank part 100. As described later, the second power part 420 may be provided in the second discharge flow passage part 230 or the second circulation flow passage part 320.

In this case, the second circulation flow passage part 320 may be coupled to and communicate with the second discharge flow passage part 230 at a part adjacent to the downstream end of the second discharge flow passage part 230. In the above embodiment, the distance between the part where the second discharge flow passage part 230 is coupled to and communicates with the second circulation flow passage part 320 and the downstream end of the second discharge flow passage part 230 is minimized, so that the amount of fluid remaining on the second discharge flow passage part 230 may be minimized.

In addition, the conveying force applied by the second power part 420 may be minimally lost to be transmitted to the fluid remaining in the second discharge flow passage part 230.

The circulation flow passage part 300 fluidly connects the discharge flow passage part 200 and the tank part 100. The fluid remaining in the discharge flow passage part 200 may return to the tank part 100 through the circulation flow passage part 300.

The circulation flow passage part 300 is fluidly connected to the discharge flow passage part 200. As described above, the circulation flow passage part 300 is fluidly connected to the first discharge flow passage part 220 and the second discharge flow passage part 230, respectively. Alternatively, the circulation flow passage part 300 may also be connected to the main discharge flow passage part 210.

The circulation flow passage part 300 is fluidly connected to the tank part 100. The fluid remaining in the discharge flow passage part 200 may flow along the circulation flow passage part 300 and then return to the tank part 100.

The power part 400 may be provided on the circulation flow passage part 300. As described above, the power part 400 may be provided in the circulation flow passage part 300 or the discharge flow passage part 200 to provide a conveying force for flowing the remaining fluid to the tank part 100.

In the illustrated embodiment, the circulation flow passage part 300 includes a first circulation flow passage part 310 and a second circulation flow passage part 320.

The first circulation flow passage part 310 fluidly connects the first discharge flow passage part 220 to the first sub tank member 120. The first circulation flow passage part 310 extends between the first discharge flow passage part 220 and the first sub tank member 120.

The fluid remaining in the first discharge flow passage part 220 may return to the first sub tank member 120 through the first circulation flow passage part 310. In an embodiment in which the first sub tank member 120 is configured to cool the fluid, the fluid returned to the first sub tank member 120 may be cooled again and provided to the user.

The first circulation flow passage part 310 may fluidly connect the first discharge flow passage part 220 and the first sub tank member 120 in a direct or indirect form.

That is, in the embodiment shown in FIG. 1, one end (i.e., the downstream end) of the first circulation flow passage part 310 toward the tank part 100 is fluidly connected to the inflow passage 11. In the above embodiment, a fluid flowing along the first circulation flow passage part 310 (i.e., a fluid remaining in the first discharge flow passage part 220) may be introduced into the first sub tank member 120 via the main tank member 110.

In this case, in the above embodiment, the first circulation flow passage part 310 may be coupled to and communicate with the inflow passage 11 on the downstream side of the inflow valve 12. In other words, the point at which the first circulation flow passage part 310 is coupled to and communicates with the inflow passage 11 is located between the inflow valve 12 and the main tank member 110.

In addition, in the embodiment shown in FIG. 2, one end (i.e., the downstream end) of the first circulation flow passage part 310 toward the tank part 100 is fluidly connected to the first sub tank member 120. In the above embodiment, a fluid flowing along the first circulation flow passage part 310 (i.e., a fluid remaining in the first discharge flow passage part 220) may be directly introduced into the first sub tank member 120.

In the above embodiment, the first circulation flow passage part 310 may be fluidly connected to the first sub tank member 120 at an arbitrary point. In the illustrated embodiment, the first circulation flow passage part 310 is coupled to and communicates with the lower side of the first sub tank member 120.

The other end (i.e., upstream end) coupled to the first discharge flow passage part 220 among each end in the extension direction of the first circulation flow passage part 310 may be located adjacent to the downstream end of the first discharge flow passage part 220.

That is, the first circulation flow passage part 310 may be coupled to and communicate with the first discharge flow passage part 220 at a point adjacent to the first outflow valve 14a. Accordingly, the distance between the above point and the first outflow valve 14a may be minimized, thereby minimizing the amount of fluid remaining in the first discharge flow passage part 220 without entering the first circulation flow passage part 310.

A first power part 410 may be provided in the first circulation flow passage part 310 or the first discharge flow passage part 220 coupled thereto and communicating therewith. The first power part 410 provides a conveying force for the fluid remaining in the first discharge flow passage part 220 to flow to the tank part 100 via the first circulation flow passage part 310.

The second circulation flow passage part 320 fluidly connects the second discharge flow passage part 230 to the second sub tank member 130. The second circulation flow passage part 320 extends between the second discharge flow passage part 230 and the second sub tank member 130.

The fluid remaining in the second discharge flow passage part 230 may return to the second sub tank member 130 through the second circulation flow passage part 320. In an embodiment in which the second sub tank member 130 is configured to heat the fluid, the fluid returned to the second sub tank member 130 may be heated again and provided to the user.

The second circulation flow passage part 320 may fluidly connect the second discharge flow passage part 230 and the second sub tank member 130 in a direct or indirect form.

That is, in the embodiment shown in FIG. 1, one end (i.e., the downstream end) of the second circulation flow passage part 320 toward the tank part 100 is fluidly connected to the inflow passage 11. In the above embodiment, a fluid flowing along the second circulation flow passage part 320 (i.e., a fluid remaining in the second discharge flow passage part 230) may be introduced into the second sub tank member 130 via the main tank member 110.

In this case, in the above embodiment, the second circulation flow passage part 320 may be coupled to and communicate with the inflow passage 11 on the downstream side of the inflow valve 12. In other words, the point at which the second circulation flow passage part 320 is coupled to and communicates with the inflow passage 11 is located between the inflow valve 12 and the main tank member 110.

In addition, in the embodiment shown in FIG. 2, one end (i.e., the downstream end) of the second circulation flow passage part 320 toward the tank part 100 is fluidly connected to the second sub tank member 130. In the above embodiment, a fluid flowing along the second circulation flow passage part 320 (i.e., a fluid remaining in the second discharge flow passage part 230) may be directly introduced into the second sub tank member 130.

In the above embodiment, the second circulation flow passage part 320 may be fluidly connected to the second sub tank member 130 at an arbitrary point. In the illustrated embodiment, the second circulation flow passage part 320 is coupled to and communicates with the lower side of the second sub tank member 130.

The other end (i.e., upstream end) coupled to the second discharge flow passage part 230 among each end in the extension direction of the second circulation flow passage part 320 may be located adjacent to the downstream end of the second discharge flow passage part 230.

That is, the second circulation flow passage part 320 may be coupled to and communicate with the second discharge flow passage part 230 at a point adjacent to the second outflow valve 14b. Accordingly, the distance between the above point and the second outflow valve 14b may be minimized, thereby minimizing the amount of fluid remaining in the second discharge flow passage part 230 without entering the second circulation flow passage part 320.

A second power part 420 may be provided in the second circulation flow passage part 320 or the second discharge flow passage part 230 coupled thereto and communicating therewith. The second power part 420 provides a conveying force for the fluid remaining in the second discharge flow passage part 230 to flow to the tank part 100 via the second circulation flow passage part 320.

The power part 400 provides a conveying force for the fluid remaining in the discharge flow passage part 200 to flow along the circulation flow passage part 300 to return to the tank part 100. The power part 400 may be installed in the discharge flow passage part 200 or the circulation flow passage part 300 to provide a conveying force to the fluid therein.

The power part 400 may be provided in an arbitrary shape that can provide a conveying force to the fluid. In an embodiment, the power part 400 may be provided in the form of a pump.

The power part 400 communicates with and is energized with the controller 600. The power part 400 may be operated according to the control information computed by the controller 600 to return the remaining fluid to the tank part 100.

The power part 400 may be provided in plural. The plurality of power parts 400 may be disposed in a plurality of circulation flow passage parts 300 or a plurality of discharge flow passage parts 200 communicating with the plurality of circulation flow passage parts 300, respectively.

In the illustrated embodiment, the power part 400 includes a first power part 410 and a second power part 420.

The first power part 410 provides a conveying force for returning the fluid flowing out of the first sub tank member 120 and remaining in the first discharge flow passage part 220 to the first sub tank member 120.

The first power part 410 may be disposed at an arbitrary position capable of providing a conveying force to the fluid remaining in the first discharge flow passage part 220. The first power part 410 may be disposed in the first discharge flow passage part 220 or the first circulation flow passage part 310 fluidly connected to the first discharge flow passage part 220. In the illustrated embodiment, the first power part 410 is disposed in the first discharge flow passage part 220.

The second power part 420 provides a conveying force for returning the fluid flowing out of the second sub tank member 130 and remaining in the second discharge flow passage part 230 to the second sub tank member 130.

The second power part 420 may be disposed at an arbitrary position capable of providing a conveying force to the fluid remaining in the second discharge flow passage part 230. The second power part 420 may be disposed in the second discharge flow passage part 230 or the second circulation flow passage part 320 fluidly connected to the second discharge flow passage part 230. In the illustrated embodiment, the second power part 420 is disposed in the second circulation flow passage part 320.

The sensor part 500 generates arbitrary detection information related to the operation of the water purifier 10. The detection information generated by the sensor part 500 is transmitted to the controller 600 and used to compute control information for controlling components of the water purifier 10. The sensor part 500 communicates with and is energized with the controller 600.

The sensor part 500 may be provided in an arbitrary form capable of generating detection information related to the operation of the water purifier 10. In the illustrated embodiment, the sensor part 500 includes a temperature sensor that generates detection information on a temperature and a flow sensor that generates detection information on a flow of a fluid.

The sensor part 500 may be provided in plural. The plurality of sensor parts 500 may generate different types of detection information at different positions.

In the illustrated embodiment, the sensor part 500 includes an external temperature sensor 510, an internal temperature sensor 520, an inflow sensor 530, and an outflow sensor 540.

The external temperature sensor 510 generates detection information on an external temperature of the water purifier 10. In other words, the external temperature sensor 510 generates detection information on the temperature of the environment in which the water purifier 10 is provided.

The detection information generated by the external temperature sensor 510 is transmitted to the controller 600 and used to compute information related to the climate at the time when the water purifier 10 is used. In an embodiment, the computed information may be season-related information.

The internal temperature sensor 520 generates detection information on the temperature of the fluid flowing or remaining inside the water purifier 10. In other words, the internal temperature sensor 520 generates detection information on the temperature of each fluid flowing out of the water purifier 10 after cooled or heated in the tank part 100 or the temperature of the fluid remaining in the discharge flow passage part 200.

The detection information generated by the internal temperature sensor 520 is transmitted to the controller 600 and used to compute information related to the temperature of the fluid extracted from the water purifier 10.

The internal temperature sensor 520 may be provided in plural. The plurality of internal temperature sensors 520 may be respectively disposed in the plurality of discharge flow passage parts 200 to generate detection information on the temperature of the fluid flowing therein or remaining therein. In the illustrated embodiment, the internal temperature sensor 520 includes a first internal temperature sensor 521 and a second internal temperature sensor 522.

Alternatively, although not shown, the internal temperature sensor 520 may include an additional component provided in the main discharge flow passage part 210 to generate detection information on the temperature of the fluid flowing out of the main tank member 110.

The first internal temperature sensor 521 is provided in the first discharge flow passage part 220 and generates detection information on the temperature of the fluid flowing or remaining in the first discharge flow passage part 220. In an embodiment in which the first sub tank member 120 is provided as a cold water tank, the first internal temperature sensor 521 generates detection information on the temperature of the cold water flowing or remaining in the first discharge flow passage part 220.

The second internal temperature sensor 522 is provided in the second discharge flow passage part 230 and generates detection information on the temperature of the fluid flowing or remaining in the second discharge flow passage part 230. In an embodiment in which the second sub tank member 130 is provided as a hot water tank, the second internal temperature sensor 522 generates detection information on the temperature of the hot water flowing or remaining in the second discharge flow passage part 230.

The inflow sensor 530 generates detection information on whether fluid flows into the tank part 100 through the inflow passage 11. In other words, the inflow sensor 530 generates detection information on whether an external filtration member (not shown) and the tank part 100 are fluidly connected. The detection information generated by the inflow sensor 530 is transmitted to the controller 600 and used to compute control information for controlling the inflow valve 12.

The outflow sensor 540 generates detection information on whether fluid flows out through the outflow passage 13. In other words, the outflow sensor 540 generates detection information on whether the water purifier 10 is in use, that is, whether the fluid stored in the tank part 100 is extracted. The detection information generated by the outflow sensor 540 is transmitted to the controller 600 and used to compute information on whether the water purifier 10 is used.

The outflow sensor 540 may be provided in plural. The plurality of outflow sensors 540 may be disposed in the plurality of outflow passages 13, respectively, to generate detection information on whether fluid flows. In the illustrated embodiment, the outflow sensor 540 includes a first outflow sensor 541 and a second outflow sensor 542.

Alternatively, although not shown, the outflow sensor 540 may be further provided on a portion (i.e., a branched flow passage) of the upstream side of the first outflow passage 13a fluidly connected to the main discharge flow passage part 210. In the above embodiment, the added outflow sensor 540 may generate detection information on whether the fluid accommodated in the main tank member 110 flows out of the water purifier 10.

The first outflow sensor 541 is provided in the first outflow passage 13a and generates detection information on whether the fluid stored in the tank part 100 flows out of the water purifier 10 through the first outflow passage 13a.

As described above, the downstream side of the first outflow passage 13a may be branched into a plurality of branches to be fluidly connected to the main discharge flow passage part 210 and the first discharge flow passage part 220, respectively. In this case, the first outflow sensor 541 may be positioned on a flow passage fluidly connected to the first discharge flow passage part 220 among the downstream portions of the first outflow passage 13a branched into a plurality of branches.

That is, in an embodiment, the first outflow sensor 541 may generate detection information on whether the fluid accommodated in the first sub tank member 120 flows out of the water purifier 10.

The second outflow sensor 542 is provided in the second outflow passage 13b and generates detection information on whether the fluid stored in the tank part 100 flows out of the water purifier 10 through the second outflow passage 13b.

As described above, the second outflow passage 13b is fluidly connected to the second discharge flow passage part 230. Accordingly, the second outflow sensor 542 may generate detection information on whether the fluid accommodated in the second sub tank member 130 flows out of the water purifier 10.

The controller 600 computes control information for controlling each component of the water purifier 10 using the detection information generated by the sensor part 500. The controller 600 may control each component of the water purifier 10 according to the computed control information.

Accordingly, a flow passage through which the fluid passing through the filtration member (not shown) flows in or the fluid stored in the tank part 100 flows out of the water purifier 10 may be formed inside the water purifier 10. In addition, a flow passage for returning the fluid remaining in the discharge flow passage part 200 to the tank part 100 may be formed inside the water purifier 10.

The controller 600 may receive detection information generated by the sensor part 500. The controller 600 communicates with and is energized with the sensor part 500.

The controller 600 may control each component of the water purifier according to the computed control information. The controller 600 communicates with and is energized with each component of the water purifier 10.

The controller 600 may be provided in an arbitrary form capable of inputting, computing, and outputting information. In an embodiment, the controller 600 may include a component for computation, such as a microprocessor, a CPU, or the like. In addition, the controller 600 may include a component for storing information. The component may be provided as a micro SD (secure disk), a solid state drive (SSD), a hard disk drive (HDD), or the like.

In the illustrated embodiment, the controller 600 includes a communication module 610, a computation module 620, and a flow passage control module 630. The communication module 610, the computation module 620, and the flow passage control module 630 communicate with each other and are energized with each other.

The communication module 610 communicates and energizes other components of the water purifier 10 with the controller 600. The communication module 610 may connect the controller 600 to other components of the water purifier 10 in a wired or wireless form so as to communicate and energize with each other.

In the illustrated embodiment, the communication module 610 includes a sensor communication unit 611.

The sensor communication unit 611 communicatively connects the sensor part 500 and the controller 600 to communicate with each other. The detection information generated by the sensor communication unit 611 may be transmitted to the sensor communication unit 611.

As described above, the sensor part 500 may include a plurality of sensors 510, 520, 530, and 540 that generate different detection information. The sensor communication unit 611 may be communicatively connected to each of the plurality of sensors 510, 520, 530, and 540 to receive detection information generated by each of the sensors 510, 520, 530, and 540.

The detection information received by the sensor communication unit 611 is transmitted to the computation module 620.

The computation module 620 computes information on the fluid flow formed inside the water purifier 10, that is, flow passage information, by using the detection information generated by the sensor part 500. In addition, the computation module 620 computes control information for controlling the flow passage of the fluid using the detection information generated by the sensor part 500 and the computed flow passage information.

The computation module 620 may include a plurality of components. Some of the plurality of components of the computation module 620 may compute information on the state of the water purifier 10. Another some of the plurality of components of the computation module 620 may compute flow passage information on a flow passage formed inside the water purifier 10. Yet another some of the plurality of components of the computation module 620 may compute control information for controlling the components of the water purifier 10 to form a specific flow passage inside the water purifier 10.

In the illustrated embodiment, the computation module 620 includes an inflow control information computation unit 621, a first flow passage information computation unit 622, a first circulation control information computation unit 623, a second flow passage information computation unit 624, and a second circulation control information computation unit 625.

The inflow control information computation unit 621 computes inflow control information using the detection information generated by the inflow sensor 530 and the outflow sensor 540. The inflow control information may be defined as information for controlling the inflow valve 12 so that external fluid flows into the tank part 100 through the inflow passage 11.

The inflow control information may include information for operating the inflow valve 12 so that the inflow passage 11 is opened so that an external filtration member (not shown) and the tank part 100 are fluidly connected. In addition, the inflow control information may include information for operating the inflow valve 12 so that the inflow passage 11 is closed so that the external filtration member (not shown) and the tank part 100 are fluidly blocked.

As will be described later, the water purifier 10 according to an exemplary embodiment of the present invention may return the fluid remaining in the discharge flow passage part 200 to the tank part 100 when not used for a long time. Accordingly, the inflow control information computation unit 621 may compute information related to whether the water purifier 10 is used, the unused elapsed time of the water purifier 10, and the like using the detection information generated by the outflow sensor 540.

The inflow control information computation unit 621 may compute inflow control information for closing the inflow valve 12 if the water purifier 10 is not used for a preset reference time or more based on the computed information. In addition, the inflow control information computation unit 621 may compute inflow control information for opening the inflow valve 12 if the water purifier 10 is in use or if the water purifier 10 not used less than a preset reference time based on the computed information.

The preset reference time may be defined as a time sufficient for a temperature change of the fluid remaining in the discharge flow passage part 200 to affect the temperature of the fluid newly flowing out of the tank part 100.

That is, the preset reference time may be defined as a time sufficient for the cold water remaining in the first discharge flow passage part 220 to be heated enough to affect the temperature of the cold water flowing out of the first sub tank member 120. In addition, the preset reference time may be defined as a time sufficient for the hot water remaining in the second discharge flow passage part 230 to be cooled enough to affect the temperature of the hot water flowing out of the second sub tank member 130.

The inflow control information computed by the inflow control information computation unit 621 is transmitted to the flow passage control module 630 and used to control the inflow valve 12. The inflow control information computation unit 621 communicates with and is energized with the flow passage control module 630.

The first flow passage information computation unit 622 computes first flow passage information using the detection information generated by the first outflow sensor 541. The first flow passage information may be defined as information on whether the fluid accommodated in the first sub tank member 120 flows out of the water purifier 10 through the first discharge flow passage part 220.

The first flow passage information computed by the first flow passage information computation unit 622 is transmitted to the first circulation control information computation unit 623. The first flow passage information computation unit 622 and the first circulation control information computation unit 623 communicate with and is energized with each other.

The first circulation control information computation unit 623 computes first circulation control information using the detection information generated by the external temperature sensor 510 or the first internal temperature sensor 521 and the first flow passage information computed by the first flow passage information computation unit 622.

The first circulation control information may be defined as information for controlling each component of the water purifier 10 to form a flow passage for returning the fluid flowing out of the first sub tank member 120 and remaining in the first discharge flow passage part 220 to the first sub tank member 120.

The first circulation control information may include information for controlling the inflow valve 12. That is, in order for the fluid remaining in the first discharge flow passage part 220 to flow smoothly to the first sub tank member 120, the external filtration member (not shown) and the tank part 100 must be fluidly blocked. Accordingly, the first circulation control information may include information for controlling the inflow valve 12 so that the inflow passage 11 is opened or closed.

The first circulation control information may include information for controlling the first power part 410 of the power part 400. As described above, the first power part 410 provides a conveying force for the fluid remaining in the first discharge flow passage part 220 to flow to the first sub tank member 120. Accordingly, the first circulation control information may include information for controlling the first power part 410 to be operated or stopped.

In addition, the first circulation control information may include any information related to the operation of the first power part 410, such as the operation speed of the first power part 410, the operation time of the first power part 410, and the operation cycle of the first power part 410.

The first circulation control information computation unit 623 may compute first circulation control information using the computed first flow passage information.

Specifically, if the computed first flow passage information means that the fluid is extracted through the first outflow passage 13a, that is, if the fluid is flowing on the first outflow passage 13a, it may be inferred that the fluid is being extracted by the user. Therefore, in this case, since the water purifier 10 is in use, it is preferable that the process of returning the fluid remaining in the first discharge flow passage part 220 is not performed.

Accordingly, the first circulation control information computation unit 623 computes first circulation control information that does not operate the first power part 410, that is, that does not perform a process of returning the fluid remaining in the first discharge flow passage part 220.

On the other hand, if the computed first flow passage information means that the fluid is not extracted through the first outflow passage 13a, that is, if the fluid does not flow on the first outflow passage 13a, it may be inferred that the user does not extract the fluid. Therefore, in this case, since the water purifier 10 is not in use, it is preferable to return the fluid remaining in the first discharge flow passage part 220 if the water purifier 10 is not in use for a preset reference time or more.

Accordingly, the first circulation control information computation unit 623 computes first circulation control information that operates the first power part 410, that is, that performs a process of returning the fluid remaining in the first discharge flow passage part 220.

The first circulation control information computation unit 623 may compute first circulation control information using the computed detection information generated by the external temperature sensor 510. For example, the first circulation control information computation unit 623 may compute information on a season to which the current time point corresponds using the detection information generated by the external temperature sensor 510.

As described above, in an embodiment in which the first sub tank member 120 is configured to generate cold water, if the computed information on the season is summer, the first circulation control information computation unit 623 may compute first circulation control information so that the operation time of the first power part 410 is increased and the operation cycle of the first power part 410 is decreased (i.e., operated more frequently).

The first circulation control information computation unit 623 may compute first circulation control information using the computed detection information generated by the first internal temperature sensor 521. For example, the first circulation control information computation unit 623 may compare the detection information generated by the first internal temperature sensor 521 with a preset first reference temperature to compute information related to a temperature change of the fluid.

The first reference temperature may be defined as a target temperature at which the fluid accommodated in the first sub tank member 120 must be heated or cooled to be reached. In an embodiment in which the first sub tank member 120 is configured to generate cold water, the first reference temperature may be defined as a target temperature for cooling the fluid.

As described above, in an embodiment in which the first sub tank member 120 is configured to generate cold water, information related to the temperature change of the fluid may be computed using the difference between the detection information generated by the first internal temperature sensor 521 and the first reference temperature.

In the above embodiment, when the computed information related to the temperature change of the fluid is excessive, the first circulation control information computation unit 623 may compute first circulation control information so that the operation speed of the first power part 410 increases. That is, the computed first circulation control information may include information for increasing or decreasing the operation speed of the first power part 410 in proportion to the magnitude of the absolute value of the information related to the computed temperature change of the fluid.

The first circulation control information computed by the first circulation control information computation unit 623 is transmitted to the flow passage control module 630. The first circulation control information computation unit 623 and the flow passage control module 630 communicate with and is energized with each other.

The second flow passage information computation unit 624 computes second flow passage information using the detection information generated by the second outflow sensor 542. The second flow passage information may be defined as information on whether the fluid accommodated in the second sub tank member 130 flows out of the water purifier 10 through the second discharge flow passage part 230.

The second flow passage information computed by the second flow passage information computation unit 624 is transmitted to the second circulation control information computation unit 625. The second flow passage information computation unit 624 and the second circulation control information computation unit 625 communicate with and is energized with each other.

The second circulation control information computation unit 625 computes second circulation control information using the detection information generated by the external temperature sensor 510 or the second internal temperature sensor 522 and the second flow passage information computed by the second flow passage information computation unit 624.

The second circulation control information may be defined as information for controlling each component of the water purifier 10 to form a flow passage for returning the fluid flowing out of the second sub tank member 130 and remaining in the second discharge flow passage part 230 to the second sub tank member 130.

The second circulation control information may include information for controlling the inflow valve 12. That is, in order for the fluid remaining in the second discharge flow passage part 230 to flow smoothly to the second sub tank member 130, the external filtration member (not shown) and the tank part 100 must be fluidly blocked. Accordingly, the second circulation control information may include information for controlling the inflow valve 12 so that the inflow passage 11 is opened or closed.

The second circulation control information may include information for controlling the second power part 420 of the power part 400. As described above, the second power part 420 provides a conveying force for the fluid remaining in the second discharge flow passage part 230 to flow to the second sub tank member 130. Accordingly, the second circulation control information may include information for controlling the second power part 420 to be operated or stopped.

In addition, the second circulation control information may include any information related to the operation of the second power part 420, such as the operation speed of the second power part 420, the operation time of the second power part 420, and the operation cycle of the second power part 420.

The second circulation control information computation unit 625 may compute second circulation control information using the computed second flow passage information.

Specifically, if the computed second flow passage information means that the fluid is extracted through the second outflow passage 13b, that is, if the fluid is flowing on the second outflow passage 13b, it may be inferred that the fluid is being extracted by the user. Therefore, in this case, since the water purifier 10 is in use, it is preferable that the process of returning the fluid remaining in the second discharge flow passage part 230 is not performed.

Accordingly, the second circulation control information computation unit 625 computes second circulation control information that does not operate the second power part 420, that is, that does not perform a process of returning the fluid remaining in the second discharge flow passage part 230.

On the other hand, if the computed second flow passage information means that the fluid is not extracted through the second outflow passage 13b, that is, if the fluid does not flow on the second outflow passage 13b, it may be inferred that the user does not extract the fluid. Therefore, in this case, since the water purifier 10 is not in use, it is preferable to return the fluid remaining in the second discharge flow passage part 230 if the water purifier 10 is not in use for a preset reference time or more.

Accordingly, the second circulation control information computation unit 625 computes second circulation control information that operates the second power part 420, that is, that performs a process of returning the fluid remaining in the second discharge flow passage part 230.

The second circulation control information computation unit 625 may compute second circulation control information using the computed detection information generated by the external temperature sensor 510. For example, the second circulation control information computation unit 625 may compute information on a season to which the current time point corresponds using the detection information generated by the external temperature sensor 510.

As described above, in an embodiment in which the second sub tank member 130 is configured to generate hot water, if the computed information on the season is winter, the second circulation control information computation unit 625 may compute second circulation control information so that the operation time of the second power part 420 is increased and the operation cycle of the second power part 420 is decreased (i.e., operated more frequently).

The second circulation control information computation unit 625 may compute second circulation control information using the computed detection information generated by the second internal temperature sensor 522. For example, the second circulation control information computation unit 625 may compare the detection information generated by the second internal temperature sensor 522 with a preset second reference temperature to compute information related to a temperature change of the fluid.

The second reference temperature may be defined as a target temperature at which the fluid accommodated in the second sub tank member 130 must be heated or cooled to be reached. In an embodiment in which the second sub tank member 130 is configured to generate hot water, the second reference temperature may be defined as a target temperature for heating the fluid.

As described above, in an embodiment in which the second sub tank member 130 is configured to generate hot water, information related to the temperature change of the fluid may be computed using the difference between the detection information generated by the second internal temperature sensor 522 and the second reference temperature.

In the above embodiment, when the computed information related to the temperature change of the fluid is excessive, the second circulation control information computation unit 625 may compute second circulation control information so that the operation speed of the second power part 420 increases. That is, the computed second circulation control information may include information for increasing or decreasing the operation speed of the second power part 420 in proportion to the magnitude of the absolute value of the information related to the computed temperature change of the fluid.

The second circulation control information computed by the second circulation control information computation unit 625 is transmitted to the flow passage control module 630. The second circulation control information computation unit 625 and the flow passage control module 630 communicate and is energized with each other.

The flow passage control module 630 controls each component of the water purifier 10 using the computed control information. The flow passage control module 630 may form various flow passages inside the water purifier 10 through the above process.

The flow passage control module 630 communicates with and is energized with each component of the water purifier 10. The flow passage control module 630 may control the operation of each component of the water purifier 10. In an embodiment, the flow passage control module 630 may communicate with and be energized with the inflow valve 12, the outflow valve 14, and the power part 400.

The flow passage control module 630 may receive the computed control information, that is, the inflow control information, the first circulation control information, and the second circulation control information. The flow passage control module 630 communicates with and is energized with the computation module 620.

In the illustrated embodiment, the flow passage control module 630 includes a main flow passage control unit 631, a first flow passage control unit 632, and a second flow passage control unit 633.

The main flow passage control unit 631 controls the inflow valve 12 so that the external filtration member (not shown) and the tank part 100 are fluidly connected or blocked. The main flow passage control unit 631 communicates with and is energized with the inflow valve 12.

The main flow passage control unit 631 may control the inflow valve 12 according to the computed inflow control information. The main flow passage control unit 631 communicates with and is energized with the inflow control information computation unit 621.

When additional fluid needs to be introduced into the main tank member 110, the main flow passage control unit 631 controls the inflow valve 12 so that the inflow passage 11 is opened. Accordingly, the external filtration member (not shown) and the tank part 100 may be fluidly connected.

When the inflow of additional fluid into the main tank member 110 must be blocked, the main flow passage control unit 631 controls the inflow valve 12 so that the inflow passage 11 is closed. Accordingly, the external filtration member (not shown) and the tank part 100 may be fluidly clocked.

In the above state, the fluid remaining in the discharge flow passage part 200 may return to the tank part 100 through the circulation flow passage part 300.

The first flow passage control unit 632 controls the operation of the first power part 410 so that the fluid remaining in the first discharge flow passage part 220 returns to the first sub tank member 120. The first flow passage control unit 632 communicates with and is energized with the first power part 410.

The first flow passage control unit 632 may control the first power part 410 according to the computed first circulation control information. The first flow passage control unit 632 communicates with and is energized with the first circulation control information computation unit 623.

When a part of the fluid flowing out from the first sub tank member 120 remains in the first discharge flow passage part 220, the first flow passage control unit 632 controls the first power part 410 so that the remaining fluid flows to the first circulation flow passage part 310. The first power part 410 may provide a conveying force so that the fluid remaining in the first discharge flow passage part 220 flows via the first circulation flow passage part 310 to the first sub tank member 120.

The second flow passage control unit 633 controls the operation of the second power part 420 so that the fluid remaining in the second discharge flow passage part 230 returns to the second sub tank member 130. The second flow passage control unit 633 communicates with and is energized with the second power part 420.

The second flow passage control unit 633 may control the second power part 420 according to the computed second circulation control information. The second flow passage control unit 633 communicates with and is energized with the second circulation control information computation unit 625.

When a part of the fluid flowing out from the second sub tank member 130 remains in the second discharge flow passage part 230, the second flow passage control unit 633 controls the second power part 420 so that the remaining fluid flows to the second circulation flow passage part 320. The second power part 420 may provide a conveying force so that the fluid remaining in the second discharge flow passage part 230 flows via the second circulation flow passage part 320 to the second sub tank member 130.

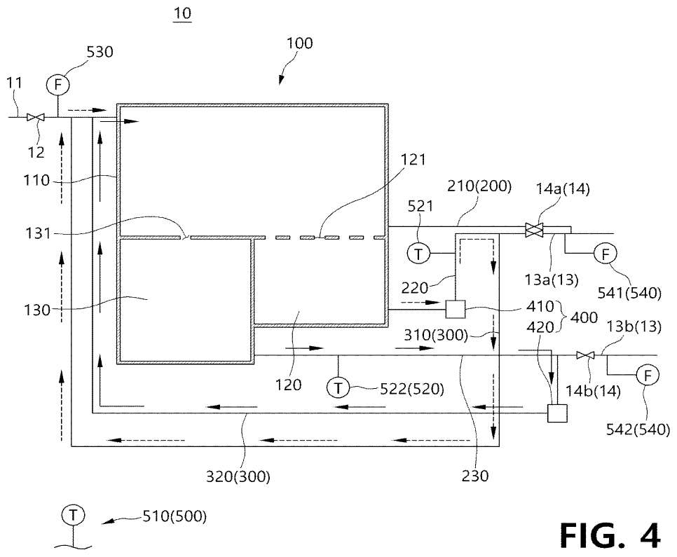

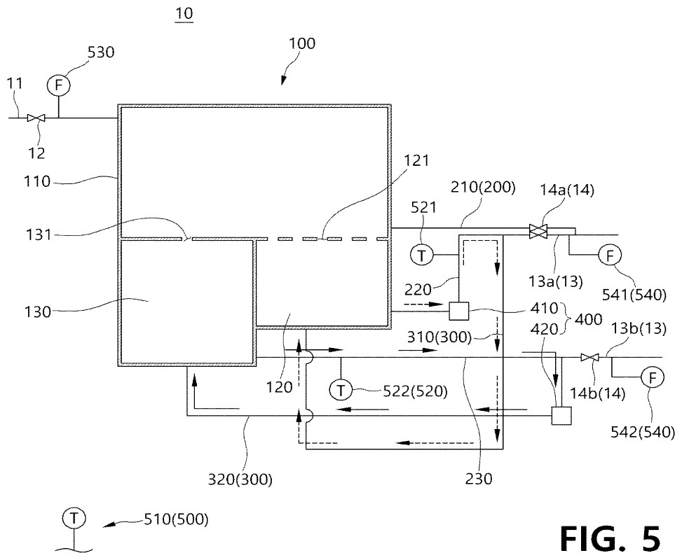

Referring to FIGS. 4 to 5, a return (or circulation) flow passage of fluid formed inside the water purifier 10 according to an exemplary embodiment of the present invention is illustrated.

Referring to FIG. 4, a flow passage through which the fluid remaining in the discharge flow passage part 200 returns is illustrated when the circulation flow passage part 300 is fluidly connected to the main tank member 110 through the inflow passage 11. As shown in FIG. 1, the circulation flow passage part 300 is fluidly connected to the sub tank members 120 and 130 indirectly through the inflow passage 11 and the main tank member 110.

When the first power part 410 is operated, a conveying force in a direction toward the main tank member 110 is applied to the fluid remaining in the first discharge flow passage part 220. Accordingly, the remaining fluid flows into the main tank member 110 via the first circulation flow passage part 310 fluidly connected to the first discharge flow passage part 220.

Similarly, when the second power part 420 is operated, a conveying force in a direction toward the main tank member 110 is applied to the fluid remaining in the second discharge flow passage part 230. Accordingly, the remaining fluid flows into the main tank member 110 via the second circulation flow passage part 320 fluidly connected to the second discharge flow passage part 230.

The fluid introduced into the main tank member 110 may flow out to the first sub tank member 120 or the second sub tank member 130 to be cooled or heated and then provided to the user. Therefore, the amount of fluid remaining in the discharge flow passage part 200 may be minimized. Accordingly, even though water accommodated in the first sub tank member 120 or the second sub tank member 130 is discharged after a long period of non-use, a temperature change of the discharged fluid may be minimized.

In addition, since the fluid remaining in the discharge flow passage part 200 is recovered to the tank part 100 and discharged again, the amount of fluid used may be reduced.

Referring to FG. 5, a flow passage through which the fluid remaining in the discharge flow passage part 200 returns is illustrated when the circulation flow passage part 300 is fluidly connected to the sub tank members 120 and 130. As shown in FIG. 2, the circulation flow passage part 300 is directly fluidly connected to the sub tank members 120 and 130.

When the first power part 410 is operated, a conveying force in a direction toward the first sub tank member 120 is applied to the fluid remaining in the first discharge flow passage part 220. Accordingly, the remaining fluid flows along the first discharge flow passage part 220 and is introduced into the first sub tank member 120.

When the second power part 420 is operated, a conveying force in a direction toward the second sub tank member 130 is applied to the fluid remaining in the second discharge flow passage part 230. Accordingly, the remaining fluid flows along the second discharge flow passage part 230 and is introduced into the second sub tank member 130.

The fluid introduced into each of the sub tank members 120 and 130 may be cooled or heated again and then provided to the user.

That is, in the case of the embodiment shown in FIG. 5, the fluid flowing out of each of the sub tank members 120 and 130 and remaining in each of the discharge flow passage parts 220 and 230 may return to the sub tank members 120 and 130 initially accommodated. Therefore, among the fluids returned to each of the sub tank members 120 and 130, the pre-heated fluid may be heated again, and the pre-cooled fluid may be cooled again. Accordingly, energy efficiency may be further improved.

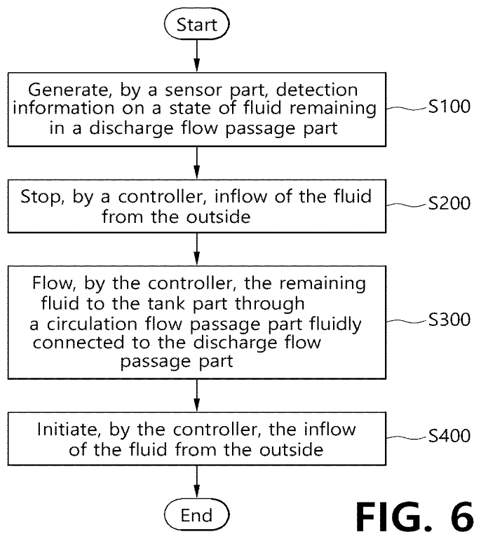

Referring to FIGS. 6 to 10, a control method of the water purifier 10 according to an exemplary embodiment of the present invention is illustrated. The control method of the water purifier 10 according to the illustrated embodiment may be performed by each component of the water purifier 10 described above.

Referring to FIG. 6, the control method of the water purifier 10 according to the illustrated embodiment includes generating, by the sensor part 500, detection information on the state of the fluid remaining in the discharge flow passage part 200 (S100); stopping, by the controller 600, the inflow of fluid from the outside (S200); flowing, by the controller 600, the remaining fluid to the tank part 100 through the circulation flow passage part 300 fluidly connected to the discharge flow passage part 200 (S300); and initiating, by the controller 600, the inflow of fluid from the outside (S400).

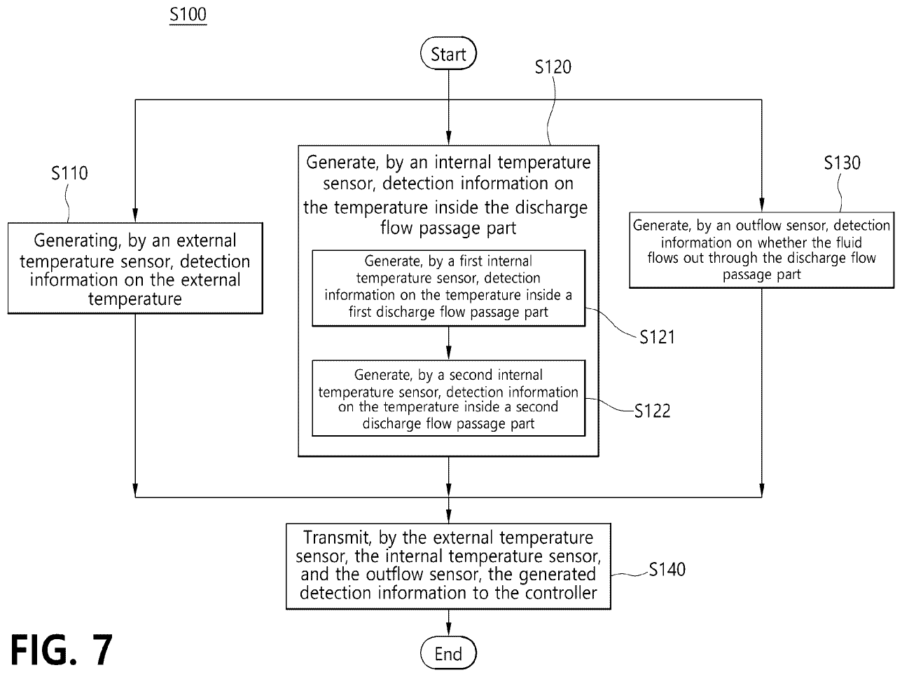

Referring to FIG. 7, a detailed flow of step S100 of generating, by the sensor part 500, detection information on the state of the fluid remaining in the discharge flow passage part 200 is illustrated. This step S100 is a step S100 in which the sensor part 500 provided in the water purifier 10 generates various detection information on the state of the water purifier 10 and transmits the various detection information to the controller 600.

The external temperature sensor 510 generates detection information on an external temperature of the water purifier 10 (S110). The generated detection information is used to compute information related to a season or the like at the corresponding time point.

The internal temperature sensor 520 generates detection information on the temperature inside the discharge flow passage part 200 (S120). As described above, a plurality of discharge flow passage parts 200 may be provided, and the internal temperature sensor 520 may be disposed on each of the plurality of discharge flow passage parts 200. Accordingly, this step S120 may be subdivided as follows.

The first internal temperature sensor 521 generates detection information on the temperature inside the first discharge flow passage part 220 (S121). In an embodiment in which the first sub tank member 120 fluidly connected to the first discharge flow passage part 220 generates cold water, the first internal temperature sensor 521 generates detection information on the temperature of the cold water flowing or remaining in the first discharge flow passage part 220.

In addition, the second internal temperature sensor 522 generates detection information on the temperature inside the second discharge flow passage part 230 (S122). In an embodiment in which the second sub tank member 130 fluidly connected to the second discharge flow passage part 230 generates hot water, the second internal temperature sensor 522 generates detection information on the temperature of the hot water flowing or remaining in the second discharge flow passage part 230.

The outflow sensor 540 generates detection information on whether fluid flows out through the discharge flow passage part 200 (S130). This step S130 is a step S130 generating detection information on whether the user uses the water purifier 10 to extract the fluid. The generated detection information is used to compute information related to whether the water purifier 10 is in use, and the elapsed time if the water purifier 10 is not in use.

The external temperature sensor 510, the internal temperature sensor 520, and the outflow sensor 540 transmit each generated detection information to the controller 600 (S140).

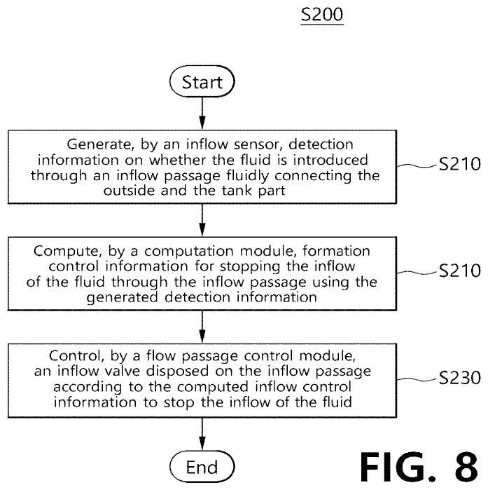

Referring to FIG. 8, a step S200 of stopping, by the controller 600, the inflow of fluid from the outside is illustrated. This step S200 is a step S200 of blocking the flow of the fluid introduced from the outside in order to recover the fluid remaining in the discharge flow passage part 200 back to the tank part 100.

The inflow sensor 530 generates detection information on whether fluid is introduced through the inflow passage 11 fluidly connecting the outside and the tank part 100 (S210). Specifically, the inflow sensor 530 is disposed in the inflow passage 11 and generates detection information on whether fluid is introduced into the main tank member 110. The generated detection information is transmitted to the computation module 620 of the controller 600.

The computation module 620 computes inflow control information for stopping the inflow of the fluid through the inflow passage 11 using the generated detection information (S220). In this case, it will be understood that the inflow control information computed by the computation module 620 is information for controlling the inflow valve 12 so that the inflow passage 11 is blocked.

In this case, the computation module 620 may compute inflow control information by further using the detection information generated by the outflow sensor 540. That is, the computation module 620 may compute information related to whether the water purifier 10 is in use, and the unused elapsed time of the water purifier 10, and the like using the detection information generated by the outflow sensor 540.

When the computed unused elapsed time is greater than or equal to a preset reference time, the computation module 620 may compute inflow control information for performing the recovery operation of the fluid remaining in the discharge flow passage part 200.

The flow passage control module 630 controls the inflow valve 12 disposed on the inflow passage 11 according to the computed inflow control information to stop the inflow of fluid (S230). That is, the flow passage control module 630 controls the inflow valve 12 so that the inflow passage 11 is blocked. Accordingly, the process of flow of fluid from the outside into the tank part 100 is blocked, so that the process of recovering the fluid remaining in the discharge flow passage part 200 may proceed.

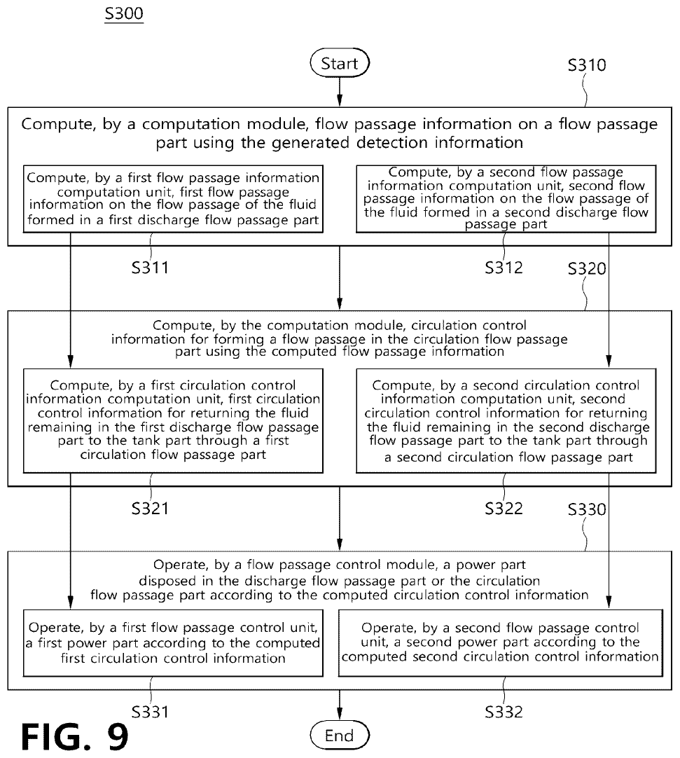

Referring to FIG. 9, a step S300 of flowing, by the controller 600, the remaining fluid to the tank part 100 through the circulation flow passage part 300 fluidly connected to the discharge flow passage part 200 is illustrated. This step S300 is a step S300 of recovering the fluid remaining in the discharge flow passage part 200 and supplying the fluid back to the tank part 100.

This step S300 may be divided into steps S311, S321, and S331 in which the fluid flowing out from the first sub tank member 120 and remaining on the first discharge flow passage part 220 is recovered and steps S321, S322, and S332 in which the fluid flowing out from the second sub tank member 130 and remaining on the second discharge flow passage part 230 is recovered.

In this case, the steps S311, S321, and S331 of recovering the fluid remaining on the first discharge flow passage part 220 and the steps S312, S322, and S332 of recovering the fluid remaining on the second discharge flow passage part 230 may be performed independently of each other.

First, the computation module 620 computes flow passage information on the flow passage of the fluid formed in the discharge flow passage part 200 using the generated detection information (S310). That is, in this step S310, the flow passage information computed by the computation module 620 may be defined as information on whether the fluid accommodated in the tank part 100 is discharged to the outside through the discharge flow passage part 200.

This step S310 may be divided into a step S311 of computing first flow passage information and a step S312 of computing second flow passage information.

First, the first flow passage information computation unit 622 computes first flow passage information, which is information on a flow passage of fluid formed in the first discharge flow passage part 220 (S311). The first flow passage information computed in this step S311 may be defined as information on whether the fluid stored in the first sub tank member 120 is extracted to the outside through the first discharge flow passage part 220.

In addition, the second flow passage information computation unit 624 computes second flow passage information, which is information on a flow passage of fluid formed in the second discharge flow passage part 230 (S312). The second flow passage information computed in this step S312 may be defined as information on whether the fluid stored in the second sub tank member 130 is extracted to the outside through the second discharge flow passage part 230.

The computed first flow passage information and second flow passage information are transmitted to the circulation control information computation units 623 and 625.

Next, the computation module 620 computes circulation control information for forming a flow passage in the circulation flow passage part 300 using the computed flow passage information (S320). That is, in this step S320, according to the computed circulation control information, on the premise that the fluid is not being extracted through the discharge flow passage part 200, the circulation control information computation units 623 and 625 compute circulation control information for recovering the remaining fluid.

In this case, the computation module 620 may compute circulation control information by further using the detection information generated by the outflow sensor 540. As described above, the detection information generated by the outflow sensor 540 is due to the fact that it includes information on whether the water purifier 10 is in use and the unused elapsed time.

This step S320 may be divided into a step S321 in which the first circulation control information is computed and a step S322 in which the second circulation control information is computed.

First, the first circulation control information computation unit 623 computes first circulation control information for returning the fluid remaining in the first discharge flow passage part 220 to the tank part 100 through the first circulation flow passage part 310 (S321).

In the embodiment shown in FIG. 1, the first circulation control information computation unit 623 computes the first circulation control information so that the fluid remaining in the first discharge flow passage part 220 flows via the first circulation flow passage part 310 to the main tank member 110.

In addition, in the embodiment shown in FIG. 2, the first circulation control information computation unit 623 computes the first circulation control information so that the fluid remaining in the first discharge flow passage part 220 flows directly to the first sub tank member 120 via the first circulation flow passage part 310.

The computed first circulation control information is transmitted to the flow passage control module 630 and used to control the first power part 410.

Next, the second circulation control information computation unit 625 computes second circulation control information for returning the fluid remaining in the second discharge flow passage part 230 to the tank part 100 through the second circulation flow passage part 320 (S322).

In the embodiment shown in FIG. 1, the second circulation control information computation unit 625 computes the second circulation control information so that the fluid remaining in the second discharge flow passage part 230 flows via the second circulation flow passage part 320 to the main tank member 110.

In addition, in the embodiment shown in FIG. 2, the second circulation control information computation unit 625 computes the second circulation control information so that the fluid remaining in the second discharge flow passage part 230 flows directly to the second sub tank member 130 via the second circulation flow passage part 320.

The computed second circulation control information is transmitted to the flow passage control module 630 and used to control the second power part 420.

Next, the flow passage control module 630 operates the power part 400 disposed in the discharge flow passage part 200 or the circulation flow passage part 300 according to the computed circulation control information (S330). This step S330 is a step S330 in which the power part 400 is controlled according to the computed circulation control information, and thus the fluid remaining in the discharge flow passage part 200 is recovered to the tank part 100.

As described above, a plurality of power parts 400 may be provided and disposed in the plurality of discharge flow passage parts 220 and 230 or the plurality of circulation flow passage parts 310 and 320, respectively. Accordingly, this step S330 may be divided into a step S331 in which the first power part 410 is operated and a step S332 in which the second power part 420 is operated. Steps S331 and S332 may be performed independently of each other.

The first flow passage control unit 632 operates the first power part 410 according to the computed first circulation control information (S331). Accordingly, the fluid remaining in the first discharge flow passage part 220 is recovered to the tank part 100 via the first circulation flow passage part 310.

In this case, in the embodiment shown in FIG. 1, the fluid remaining in the first discharge flow passage part 220 is recovered to the main tank member 110 via the first circulation flow passage part 310. In addition, in the embodiment shown in FIG. 2, the fluid remaining in the first discharge flow passage part 220 is recovered to the first sub tank member 120 via the first circulation flow passage part 310.

The second flow passage control unit 633 operates the second power part 420 according to the computed second circulation control information (S331). Accordingly, the fluid remaining in the second discharge flow passage part 230 is recovered to the tank part 100 via the second circulation flow passage part 320.

In this case, in the embodiment shown in FIG. 1, the fluid remaining in the second discharge flow passage part 230 is recovered to the main tank member 110 via the second circulation flow passage part 320. In addition, in the embodiment shown in FIG. 2, the fluid remaining in the second discharge flow passage part 230 is recovered to the second sub tank member 130 via the second circulation flow passage part 320.

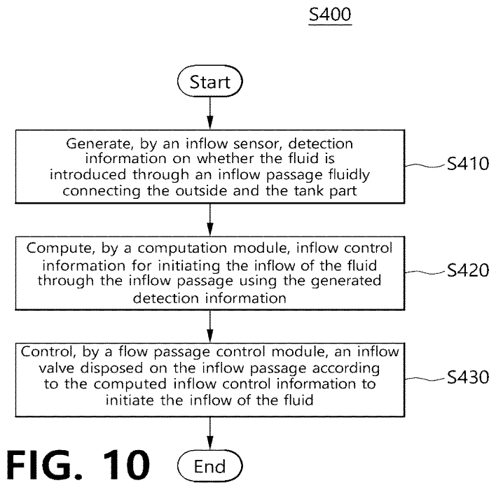

Referring to FIG. 10, a detailed flow of a step S400 of initiating, by the controller 600, the inflow of fluid from the outside is illustrated. This step S400 is a step S400 of additionally introducing the fluid into the tank part 100 to accommodate, cool, or heat the fluid after the recovery of the fluid remaining in the discharge flow passage part 200 is completed.

First, the inflow sensor 530 generates detection information on whether fluid is introduced through the inflow passage 11 fluidly connecting the outside and the tank part 100 (S410). In this step S410, the inflow sensor 530 generates detection information on whether fluid filtered from an external filtration member (not shown) is introduced into the main tank member 110.

The computation module 620 computes inflow control information for initiating the inflow of the fluid through the inflow passage 11 using the generated detection information (S420). That is, in this step S420, the inflow control information computation unit 621 computes inflow control information for opening the closed inflow passage 11 in order to circulate or return the fluid remaining in the discharge flow passage part 200 to the tank part 100.

Next, the flow passage control module 630 controls the inflow valve 12 disposed on the inflow passage 11 according to the computed inflow control information to initiate the inflow of fluid (S430). This step S430 is a step S430 in which the closed inflow passage 11 is opened and the tank part 100, specifically the main tank member 110, is fluidly connected to the outside.

Accordingly, the filtered fluid may be additionally introduced into the tank part 100 and may be provided to the user after being accommodated, cooled or heated.

Meanwhile, a step of controlling the power part 400 to stop may be further included before this step S400 is initiated.

In the above step, the first and second circulation control information computation units 623 and 625 compute circulation control information for controlling the first and second power parts 410 and 420 to stop. In addition, the first and second flow passage control units 632 and 633 of the flow passage control module 630 may stop the first and second power parts 410 and 420 according to the computed circulation control information.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the scope of the present invention.

| | |
|---|---|
| 10: water purifier | 11: inflow passage |
| 12: inflow valve | 13: outflow passage |
| 13a: first outflow passage | 13b: second outflow passage |
| 14: outflow valve | 14a: first outflow valve |
| 14b: second outflow valve | 100: tank part |
| 110: main tank member | 120: first sub tank member |
| 121: first sub communication portion | 130: second sub tank member |
| 131: second sub communication portion | 200: discharge flow passage part |
| 210: main discharge flow passage part | 220: first discharge flow passage part |
| 230: second discharge flow passage part | 300: circulation flow passage part |
| 310: first circulation flow passage part | 320: second circulation flow passage part |
| 400: power part | 410: first power part |
| 420: second power part | 500: sensor part |
| 510: external temperature sensor | 520: internal temperature sensor |
| 521: first internal temperature sensor | 522: second internal temperature sensor |
| 530: inflow sensor | 540: outflow sensor |
| 541: first outflow sensor | 542: second outflow sensor |
| 600: controller | 610: communication module |
| 611: sensor communication unit | 620: computation module |
| 621: inflow control information computation unit | 622: first flow passage information computation unit |
| 623: first circulation control information computation unit | |
| 624: second flow passage information computation unit | 625: second circulation control information computation unit |
| 630: flow passage control module | 631: main flow passage control unit |
| 632: first flow passage control unit | 633: second flow passage control unit |

1-20. (canceled)

21. A water purifier, comprising:
a tank configured to receive fluid from an external source and adjust a temperature thereof;
a discharge flow path fluidly connected to the tank and outside to form a flow path through which the fluid with adjusted temperature is discharged;
a circulation flow path fluidly connected to the tank and the discharge flow path to flow the fluid remaining in the discharge flow path into the tank; and
a power supply disposed in the discharge flow path or the circulation flow path and configured to provide a conveying force to the fluid such that the fluid returns to the tank,
wherein the circulation flow path is fluidly connected to the discharge flow path at a first point displaced downstream of the discharge flow path.

22. The water purifier of claim 21, wherein the power supply is located adjacent to the first point where the circulation flow path and the discharge flow path are fluidly connected.

23. The water purifier of claim 21, wherein the tank comprises:
a main tank configured to receive and store the fluid; and
a first sub tank member fluidly connected to the main tank and configured to cool the fluid, and
wherein the discharge flow path comprises:
a main discharge flow path fluidly connecting the main tank and the outside to form a flow path through which the stored fluid is discharged; and
a first discharge flow path fluidly connecting the first sub tank and the outside to form a flow path through which the cooled fluid is discharged.

24. The water purifier of claim 23,
wherein the circulation flow path comprises:
a first circulation flow path fluidly connected to the first discharge flow path and the main tank member to form a flow passage through which the fluid remaining in the first discharge flow path returns to the first sub tank.

25. The water purifier of claim 23,
wherein the circulation flow path includes:
a first circulation flow path fluidly connected to the first discharge flow path and the first sub tank to form a flow path through which the fluid remaining in the first discharge flow path returns to the first sub tank.

26. The water purifier of claim 24,
wherein the power supply includes:
a first power supply disposed in the first discharge flow path or the first circulation flow path to provide the conveying force to the fluid such that the fluid remaining in the first discharge flow path flows along the first circulation flow path.

27. The water purifier of claim 26,
wherein the first circulation flow path is fluidly connected to the first discharge flow path at a second point displaced downstream of the first discharge flow path, and
wherein the first power supply is disposed adjacent to the second point.

28. The water purifier of claim 21,
wherein the tank comprises:
a main tank configured to receive and store the fluid; and
a second sub tank fluidly connected to the main tank and configured to heat the fluid, and
wherein the discharge flow path comprises:
a main discharge flow path fluidly connecting the main tank and the outside to form a flow path through which the stored fluid is discharged; and
a second discharge flow path fluidly connecting the second sub tank and the outside to form a flow path through which the heated fluid is discharged.

29. The water purifier of claim 28,
wherein the circulation flow path comprises:
a second circulation flow path fluidly connected to the second discharge flow path and the main tank to form a flow path through which the fluid remaining in the second discharge flow path returns to the second sub tank.

30. The water purifier of claim 29,
wherein the circulation flow path comprises:
a second circulation flow path fluidly connected to the second discharge flow path and the second sub to form a flow path through which the fluid remaining in the second discharge flow path returns to the second sub tank.

31. The water purifier of claim 29,
wherein the power supply comprises:
a second power supply disposed in the second discharge flow path or the second circulation flow path to provide a conveying force to the fluid such that the fluid remaining in the second discharge flow path flows along the second circulation flow path.

32. The water purifier of claim 31,
wherein the second circulation flow path is fluidly connected to the second discharge flow path at a third point displaced downstream of the second discharge flow path, and
wherein the second power supply is disposed adjacent to the third point.

33. A control method of a water purifier, the method comprising:
(a) generating, by a sensor, a first detection information on a state of fluid remaining in a discharge flow path;
(b) stopping, by a controller, inflow of the fluid from the outside;
(c) flowing, by the controller, the remaining fluid to a tank through a circulation flow path fluidly connected to the discharge flow path; and
(d) initiating, by the controller, the inflow of the fluid from the outside.

34. The method of claim 33,
wherein the step (a) comprises:
(a1) generating, by an external temperature sensor, a second detection information on the external temperature;
(a2) generating, by an internal temperature sensor, a third detection information on the temperature inside the discharge flow path;
(a3) generating, by an outflow sensor, a fourth detection information on whether the fluid flows out through the discharge flow path; and
(a4) transmitting the second, the third and the fourth detection information to the controller.

35. The method of claim 34,
wherein the step (a2) comprises:
(a21) generating, by a first internal temperature sensor, a fifth detection information on the temperature inside a first discharge flow path; and
(a22) generating, by a second internal temperature sensor, a sixth detection information on the temperature inside a second discharge flow path.

36. The control method of a water purifier of claim 33,
wherein the step (b) comprises:
(b1) generating, by an inflow sensor, a seventh detection information on whether the fluid is introduced through an inflow path fluidly connecting the outside and the tank;
(b2) computing, by a computation module, inflow control information for stopping the inflow of the fluid through an inflow passage using the seventh detection information; and
(b3) controlling, by a flow passage control module, an inflow valve disposed on the inflow passage according to the computed inflow control information to stop the inflow of the fluid.

37. The control method of a water purifier of claim 33,
wherein the step (c) comprises:
(c1) computing, by a computation module, flow passage information on a flow passage of the fluid formed in the discharge flow path using the generated detection information;
(c2) computing, by the computation module, circulation control information for forming a flow passage in the circulation flow path using the computed flow passage information; and
(c3) operating, by a flow passage control module, a power supply disposed in the discharge flow path or the circulation flow path according to the computed circulation control information.

38. The control method of a water purifier of claim 37,
wherein the step (c1) comprises:
(c11) computing, by a first flow passage information computation unit, first flow passage information on the flow passage of the fluid formed in a first discharge flow path,
wherein the step (c2) comprises:
(c21) computing, by a first circulation control information computation unit, first circulation control information for returning the fluid remaining in the first discharge flow path to the tank through a first circulation flow passage part, and
wherein the step (c3) comprises:
(c31) operating, by a first flow passage control unit, a first power supply according to the computed first circulation control information.

39. The control method of a water purifier of claim 37,
wherein the step (c1) comprises:
(c12) computing, by a second flow passage information computation unit, second flow passage information on the flow passage of the fluid formed in a second discharge flow path,
wherein the step (c2) comprises:
(c22) computing, by a second circulation control information computation unit, second circulation control information for returning the fluid remaining in the second discharge flow path to the tank through a second circulation flow passage part, and
wherein the step (c3) comprises:
(c32) operating, by a second flow passage control unit, a second power supply according to the computed second circulation control information.

40. The control method of a water purifier of claim 33,
wherein the step (d) comprises:
(d1) generating, by an inflow sensor, detection information on whether the fluid is introduced through an inflow passage fluidly connecting the outside and the tank;
(d2) computing, by a computation module, inflow control information for initiating the inflow of the fluid through the inflow passage using the generated detection information; and
(d3) controlling, by a flow passage control module, an inflow valve disposed on the inflow passage according to the computed inflow control information to initiate the inflow of the fluid.
